(19) United States
(12) Patent Application Publication
(10) Pub. No.: US 2023/0284234 A1
(43) Pub. Date: Sep. 7, 2023

(54) METHOD AND DEVICE FOR TRANSMITTING AND RECEIVING DATA

(71) Applicant: Samsung Electronics Co., Ltd., Gyeonggi-do (KR)

(72) Inventors: Jingxing FU, Beijing (CN); Feifei SUN, Beijing (CN); Yi WANG, Beijing (CN); Sa ZHANG, Beijing (CN); Min WU, Beijing (CN); Qi XIONG, Beijing (CN)

(21) Appl. No.: 18/019,381

(22) PCT Filed: Jul. 21, 2021
(86) PCT No.: PCT/KR2021/009441

§ 371 Date: Feb. 2, 2023

(30) Foreign Application Priority Data
Aug. 3, 2020 (CN) 202010769440.9
Sep. 24, 2020 (CN) 202011017477.2
Mar. 12, 2021 (CN) 202110269080.0
Mar. 12, 2021 (CN) 202110272388.0
May 8, 2021 (CN) 202110502302.9

(51) Int. Cl. H04W 72/23; H04L 1/1812; H04W 72/1273

(52) U.S. Cl. CPC H04W 72/23; H04L 1/1812; H04W 72/1273

(57) ABSTRACT

A method for transmitting hybrid automatic repeat request-acknowledgement (HARQ-ACK) information comprises receiving downlink control information (DCI) including a PUCCH resource indication, the PUCCH resource indication indicates a physical uplink control channel (PUCCH) resource for transmitting HARQ-ACK information by at least one user equipment (UE), determining the physical uplink control channel (PUCCH) resource for transmitting the HARQ-ACK information according to the PUCCH resource indication, and transmitting the HARQ-ACK information on the determined PUCCH resource.

### TECHNICAL FIELD

The present disclosure relates to wireless communication technology, and in particular, to a method for uplink transmission and a user equipment. In addition, the embodiment of the present disclosure also relates to wireless communication technology, and in particular, to a method and a device for transmitting Hybrid Automatic Retransmission Request Acknowledgement (HARQ-ACK) feedback information.

### BACKGROUND ART

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

FIG. 1 shows a schematic diagram of a starting position of PUSCH in a frequency domain.

In order to improve a transmission performance of a physical uplink shared channel (PUSCH), a frequency diversity can be increased by frequency hopping. For example, the frequency hopping of PUSCH has two starting positions, namely, f_1 and f_2, at time t_1, the PUSCH is transmitted at the starting position f_1 in the frequency domain, and at time t_2, the PUSCH is transmitted at the starting position f_2 in the frequency domain, as shown in FIG. 1.

In addition, a transmission from a base station to a user equipment (UE, User Equipment) is called as downlink, and a transmission from the UE to the base station is called as uplink. The HARQ-ACK information for the Physical Downlink Shared Channel (PDSCH) may be transmitted on a Physical Uplink Shared Channel (PUSCH) or a Physical Uplink Control Channel (PUCCH), and the PDSCH is scheduled by Downlink Control Information (DCI) transmitted on a Physical Downlink Control Channel (PDCCH).

A Unicast PDSCH refers to one PDSCH received by one UE, and a scrambling of the PDSCH is based on a UE-specific Radio Network Temporary Indicator (RNTI), such as C-RNTI, and a groupcast or a multicast/broadcast PDSCH refers to one PDSCH received by more than one UE at the same time, and the scrambling of the PDSCH is based on a common RNTI of a UE group, for example, a Multicast/Broadcast Services (MBS)-RNTI.

### DISCLOSURE OF INVENTION

### Solution to Problem

According to an aspect of the present disclosure, a method for transmitting is provided, comprising: determining a number of PUSCH frequency hopping starting positions, wherein the number of PUSCH frequency hopping starting positions is determined according to a number of physical resource blocks (PRBs) of a physical uplink shared channel (PUSCH) scheduled by a user equipment (UE) and a bandwidth of an uplink active bandwidth part (BWP) where the UE is located, and transmitting the PUSCH.

In an example, the determining the number of PUSCH frequency hopping starting positions comprising: receiving the number of PUSCH frequency hopping starting positions from the base station, wherein the number of starting positions is determined by the base station according to the number of PRBs of PUSCH scheduled by UE and the bandwidth of the uplink active BWP where the UE is located.

In an example, the receiving the number of PUSCH frequency hopping starting positions from the base station comprising: the receiving the number of PUSCH frequency hopping starting positions from the base station via one of higher layer signaling, media access layer signaling and physical layer signaling.

In an example, the determining the number of PUSCH frequency hopping starting positions comprising: receiving the bandwidth of the uplink active BWP where the UE is located which is transmitted by the base station; receiving an indication information transmitted by the base station; and the number of PUSCH frequency hopping starting positions is determined from multiple candidate configurations for the number of PUSCH frequency hopping starting positions according to the bandwidth and the indication information.

In an example, the indication information is determined by the base station according to the number of PRBs of the PUSCH scheduled by the UE.

In an example, one or more candidate configurations for the number of starting positions correspond to the bandwidth of the same uplink active BWP in the multiple candidate configurations for the number of starting positions.

In an example, the determining the number of PUSCH frequency hopping starting positions comprising: receiving the number of PRBs of PUSCH scheduled by the UE and the bandwidth of the uplink active BWP where the UE is located, which are transmitted by the base station; the number of PUSCH frequency hopping starting positions is determined according to the number of PRBs of PUSCH scheduled by the UE and the bandwidth of the uplink active BWP where the UE is located.

In an example, the determining the number of PUSCH frequency hopping starting positions comprising: determining the number of PUSCH frequency hopping starting positions based on a value of Floor └M/L┘, wherein, Floor └·┘ represents a round-down operation, L represents the number of PRBs of the PUSCH to be scheduled by the UE, and M represents the bandwidth of the uplink active BWP where the UE is located.

In an example, the receiving the number of PUSCH frequency hopping starting positions from the base station comprises: receiving downlink control information (DCI) from the base station, an index of the time domain resource allocation (TDRA) in the DCI indicates the number of PUSCH frequency hopping starting positions.

In an example, the method further comprises: determining an order of PUSCH frequency hopping starting positions according to a descending order of offsets among the PUSCH frequency hopping starting positions, when the number of PUSCH frequency hopping starting positions is equal to or greater than 2.

In an example, the method further comprises: determining an order of demodulation reference signal (DMRS) bundling PUSCH group (DBPG) frequency hopping starting positions based on a number of orthogonal frequency division multiplexing (OFDM) symbols contained in the DBPG, when the number of PUSCH frequency hopping starting positions is equal to or greater than 2.

In an example, when the number of OFDM symbols contained in multiple DBPGs is the same, the order of DBPG frequency hopping starting positions is determined according to a time order of DBPG.

In an example, when the number of OFDM symbols contained in multiple DBPGs is different, the order of DBPG frequency hopping starting positions is determined according to the descending order of the number of symbols contained in the DBPG.

In an example, when the number of OFDM symbols contained in one DBPG is less than the threshold number, the DBPG frequency hopping starting position is the same as a previous DBPG frequency hopping starting position or a next DBPG frequency hopping starting position.

In an example, the PUSCH frequency hopping starting position is in the same uplink active BWP or in different uplink active BWPs.

According to another aspect of the embodiment of the disclosure, a method for receiving is provided, comprising: determining a number of physical uplink shared channel (PUSCH) frequency hopping starting positions, according to a number of physical resource blocks (PRBs) of PUSCH scheduled by the user equipment (UE) and the bandwidth of the uplink active bandwidth part (BWP) where the UE is located; and receiving PUSCH.

In an example, the method further comprises: informing the UE of the number of PUSCH frequency hopping starting positions.

In an example, the informing the UE of the number of PUSCH frequency hopping starting positions comprises: receiving the number of PUSCH frequency hopping starting positions from the base station via one of higher layer signaling, media access layer signaling and physical layer signaling.

In an example, the method further comprises: transmitting to the UE the bandwidth of the uplink active BWP where the UE is located; transmitting an indication information to the UE, wherein the bandwidth and the indication information are used as the basis for the UE to determine the number of PUSCH frequency hopping starting positions from multiple candidate configurations for the number of PUSCH frequency hopping starting positions.

In an example, the indication information is determined by the base station according to the number of PRBs of the PUSCH scheduled by the UE.

In an example, one or more candidate configurations for the number of the starting positions correspond to the bandwidth of the same uplink active BWP in the multiple candidate configurations for the number of starting positions.

In an example, the method further comprises: transmitting to the UE the number of PRBs of PUSCH scheduled by the UE and the bandwidth of the uplink active BWP where the UE is located; and wherein the number of PRBs of PUSCH scheduled by the UE and the bandwidth of the uplink active BWP where the UE is located are used as the basis for the UE to determine the number of PUSCH frequency hopping starting positions.

In an example, the UE determines the number of PUSCH frequency hopping starting positions by a following formula: Floor └M/L┘, wherein, Floor └·┘represents a round-down operation, L represents the number of PRBs of the PUSCH to be scheduled by the UE, and M represents the bandwidth of the uplink active BWP where the UE is located.

In an example, the informing the UE of the number of PUSCH frequency hopping starting positions comprises: transmitting to the UE downlink control information (DCI), an index of the time domain resource allocation (TDRA) in the DCI indicates the number of PUSCH frequency hopping starting positions.

In an example, a order of PUSCH frequency hopping starting positions is determined according to a descending order of offsets among PUSCH frequency hopping starting positions, when the number of PUSCH frequency hopping starting positions is equal to or greater than 2.

In an example, an order of demodulation reference signal (DMRS) bundling PUSCH group (DBPG) frequency hopping starting positions is determined based on a number of orthogonal frequency division multiplexing (OFDM) symbols contained in the DBPG, when the number of PUSCH frequency hopping starting positions is equal to or greater than 2.

In an example, when the number of OFDM symbols contained in multiple DBPGs is the same, an order of DBPG frequency hopping starting positions is determined according to a time order of the DBPG.

In an example, when the number of OFDM symbols contained in multiple DBPGs is different, the order of DBPG frequency hopping starting positions is determined according to a descending order of the number of symbols contained in the DBPG.

In an example, when the number of OFDM symbols contained in one DBPG is less than a threshold number, the DBPG frequency hopping starting position is the same as a previous DBPG frequency hopping starting position or a next DBPG frequency hopping starting position.

In an example, PUSCH frequency hopping starting position is in the same uplink active BWP or in different uplink active BWPs.

According to another aspect of the embodiment of the disclosure, a method for transmitting is provided, comprising: determining a number of physical uplink shared channel (PUSCH) frequency hopping starting positions; determining an order of PUSCH frequency hopping starting positions according to a descending order of offsets among the PUSCH frequency hopping starting positions, when the number of PUSCH frequency hopping starting positions is equal to or greater than 2; and transmitting the PUSCH.

According to another aspect of the embodiment of the disclosure, a method for receiving is provided, comprising: determining a number of physical uplink shared channel (PUSCH) frequency hopping starting positions; determining an order of PUSCH frequency hopping starting positions according to a descending order of offsets among the PUSCH frequency hopping starting positions, when the number of PUSCH frequency hopping starting positions is equal to or greater than 2; and receiving the PUSCH.

According to another aspect of the embodiment of the disclosure, a method for transmitting is provided, comprising: determining a number of physical uplink shared channel (PUSCH) frequency hopping starting positions; determining an order of demodulation reference signal (DMRS) bundling PUSCH group (DBPG) frequency hopping starting positions based on a number of orthogonal frequency division multiplexing (OFDM) symbols contained in the DBPG, when the number of PUSCH frequency hopping starting positions is equal to or greater than 2; and transmitting the PUSCH.

In an example, when the number of OFDM symbols contained in multiple DBPGs is the same, the order of DBPG frequency hopping starting positions is determined according to a time order of DBPG.

In an example, when the number of OFDM symbols contained in multiple DBPGs is different, the order of DBPG frequency hopping starting positions is determined according to a descending order of the number of symbols contained in DBPG.

In an example, when the number of OFDM symbols contained in one DBPG is less than the threshold number, the DBPG frequency hopping starting position is the same as a previous DBPG frequency hopping starting position or a next DBPG frequency hopping starting position.

According to another aspect of the embodiment of the disclosure, a method for receiving is provided, comprising: determining a number of physical uplink shared channel (PUSCH) frequency hopping starting positions; determining an order of demodulation reference signal (DMRS) bundling PUSCH group (DBPG) frequency hopping starting positions based on a number of orthogonal frequency division multiplexing (OFDM) symbols contained in the DBPG, when the number of PUSCH frequency hopping starting positions is equal to or greater than 2; and receiving PUSCH.

In an example, when the number of OFDM symbols contained in multiple DBPGs is the same, the order of DBPG frequency hopping starting positions is determined according to a time order of DBPG.

In an example, when the number of OFDM symbols contained in multiple DBPGs is different, the order of DBPG frequency hopping starting positions is determined according to a descending order of the number of symbols contained in the DBPG.

In an example, when the number of OFDM symbols contained in one DBPG is less than the threshold number, DBPG frequency hopping starting position is the same as a previous DBPG frequency hopping starting position or a next DBPG frequency hopping starting position.

According to another aspect of the embodiment of the disclosure, a method for transmitting is provided, comprising: receiving an indication to transmit aperiodic channel state information (CSI) on a physical uplink shared channel (PUSCH); and transmitting the aperiodic CSI on PUSCH, wherein a priority of the PUSCH and the priority of the aperiodic CSI are the same or different.

In an example, the indication is a bit included in the downlink control information (DCI) for scheduling PUSCH.

In an example, setting a correspondence relationship among the priority of the aperiodic CSI to be transmitted and the value of the CSI request information, and the indication is the value of the CSI request information.

According to another aspect of the embodiment of the disclosure, a method for transmitting hybrid automatic repeat request-acknowledgement (HARQ-ACK) information is provided, comprising: determining, by a User Equipment (UE), a total number of bits of the HARQ-ACK information; and transmitting, by the UE, the HARQ-ACK information with the determined total number of bits on PUCCH resource.

In an example, determining, by the UE, the number of bits of the HARQ-ACK information comprises: receiving, by the UE, configuration information on the number of bits of the HARQ-ACK information; and determining the number of bits of the HARQ-ACK information according to the configuration information, wherein the configuration information is a semi-static configuration information.

In an example, the number of bits of the HARQ-ACK information=a number of serving cells*bundling window per cell*a number of bits of each HARQ-ACK information.

In an example, the method further comprises: determining the number of bits of the HARQ-ACK information based on a count downlink (DL) assignment index (DAI) in downlink control information (DCI) in a PDCCH scheduling the PDSCH.

In an example, determining, by the UE, the number of bits of the HARQ-ACK information comprises: receiving, by the UE, a configuration information on the number of bits of the HARQ-ACK information; receiving the DAI; and determining the total number of bits of the HARQ-ACK information to be transmitted according to a transmission mode of the serving cell, when the DAI is equal to 1.

According to another aspect of the embodiment of the disclosure, a method for receiving hybrid automatic repeat request-acknowledgement (HARQ-ACK) information is provided, comprising: transmitting downlink control information (DCI); and receiving the HARQ-ACK information from a User Equipment (UE), wherein a total number of bits of the HARQ-ACK information is determined by the UE semi-statically.

In an example, the total number of bits of the HARQ-ACK information to be transmitted=a number of serving cells*bundling window per cell*a number of bits of each HARQ-ACK information.

In an example, the total number of bits of the HARQ-ACK information transmitted by the UE is determined based on a count downlink (DL) assignment index (DAI) in a downlink control information (DCI) in a PDCCH scheduling the PDSCH.

In an example, the total number of bits of the HARQ-ACK information to be transmitted is determined according to a transmission mode of the serving cell, when the DAI is equal to 1.

According to another aspect of the embodiment of the disclosure, a device for transmitting is provided, comprising: a transceiver for transmitting and receiving signals; a processor; and a memory for storing instructions executable by the processor, and when the instructions are executed by the processor, causing the processor to execute any of the aforementioned methods for transmitting.

According to another aspect of the embodiment of the disclosure, a device for receiving is provided, comprising: a transceiver for transmitting and receiving signals; a processor; and a memory for storing instructions executable by the processor, and when the instructions are executed by the processor, causing the processor to execute any of the aforementioned methods for receiving.

According to the embodiment of the present disclosure, the provided method for transmitting and receiving and user equipment can improve the frequency diversity gain of the uplink transmission based on the frequency hopping method of the uplink transmission by determining the frequency hopping method of the uplink transmission, thereby improving the transmission performance of the uplink and increasing the coverage of the uplink.

The embodiment of the present disclosure also provides a method for transmitting HARQ-ACK feedback information, and describes a method for transmitting HARQ-ACK of multicast PDSCH.

According to an aspect of the embodiments of the present disclosure, a method for transmitting hybrid automatic repeat request-acknowledgement (HARQ-ACK) information is provided, comprising: receiving downlink control information (DCI) including a PUCCH resource indication, the PUCCH resource indication indicates a physical uplink control channel (PUCCH) resource for transmitting HARQ-ACK information by at least one user equipment (UE); determining the physical uplink control channel (PUCCH) resource for transmitting the HARQ-ACK information according to the PUCCH resource indication; and transmitting the HARQ-ACK information on the determined PUCCH resource.

In an example, a number of the PUCCH resource indications is one, and a value of the PUCCH resource indication indicates one of multiple sets of PUCCH resource configured by a higher layer signaling, and each of the PUCCH resource included in the indicated set of PUCCH resource is respectively used for a corresponding UE in the at least one UE.

In an example, the number of the PUCCH resource indications is more than one, and each PUCCH resource indication is respectively used to indicate the PUCCH resource for transmitting the HARQ-ACK information by the corresponding UE among the at least one UE.

In an example, the number of the PUCCH resource indications is more than one, and each PUCCH resource indication is respectively used to indicate the set of PUCCH resource for transmitting the HARQ-ACK information by a corresponding UE group among the at least one UE.

In an example, the PUCCH resource indication includes a PUCCH resource indication (PRI) field.

In an example, the value of the PUCCH resource indication further indicates that some of the at least one UE do not need to transmit the HARQ-ACK information.

In an example, PUCCH candidate resources are determined through a higher layer signaling configuration; and the physical uplink control channel (PUCCH) resource for transmitting the HARQ-ACK information is determined from the PUCCH candidate resources according to the PUCCH resource indication.

In an example, a transmission power control (TPC) command is included in the DCI, and the method further comprises: determining whether to apply the TPC command according to a time unit where the DCI is located.

In an example, a plurality of transmission power control (TPC) commands are further included in the DCI, and each of the plurality of TPC commands corresponds to a corresponding UE and/or a corresponding UE group among the at least one UE.

In an example, parameters for power control of the PUCCH transmitting the HARQ-ACK for the multicast PDSCH are configured separately from parameters for power control of the PUCCH transmitting the HARQ-ACK for the unicast PDSCH.

In an example, the DCI further includes a plurality of downlink allocation indexes (DAIs), which are respectively used to count HARQ-ACK transmitted by the corresponding UE in the at least one UE.

In an example, the DCI further includes an enable field for at least one of: enabling or disabling the PUCCH resource; enabling or disabling the PUCCH resource indication; enabling or disabling the TPC command; and enabling or disabling the DAI.

In an example, the DCI is divided into a first part of DCI and a second part of DCI, the first part of DCI is transmitted on the physical downlink control channel (PDCCH), and the second part of DCI is transmitted on the multicast physical downlink shared channel (PDSCH) scheduled by the PDCCH and includes at least one of the PUCCH resource indication, the TPC command and the DAI.

In an example, an enable field is included in the first part of the DCI, and the enable field is used for at least one of: enabling or disabling the PUCCH resource; enabling or disabling the PUCCH resource indication; enabling or disabling the TPC command; and enabling or disabling the DAI.

In an example, the TPC command field indicates whether to transmit the HARQ-ACK.

In an example, a DCI format indication field in the DCI is used as a PUCCH resource enable/disable field to indicate whether to transmit the HARQ-ACK.

In an example, a value of a downlink data to uplink acknowledgement field in the DCI includes a value indicating no transmitting of the HARQ-ACK.

In an example, the method further comprises: determining a maximum retransmission number for the HARQ-ACK of the same multicast physical downlink shared channel (PDSCH).

In an example, the method further comprises: receiving information of a time window for the multicast PDSCH; and receiving the multicast PDSCH according to the information.

According to another aspect of the embodiments of the present disclosure, a method for receiving hybrid automatic repeat request-acknowledgement (HARQ-ACK) information is provided, comprising: transmitting downlink control information (DCI) including a PUCCH resource indication, the PUCCH resource indication indicates a physical uplink control channel (PUCCH) resource for transmitting the HARQ-ACK information by at least one user equipment (UE); and receiving the HARQ-ACK information on the PUCCH resource.

In an example, a number of the PUCCH resource indications is one, and a value of the PUCCH resource indication indicates one of multiple sets of PUCCH resource configured by a higher layer signaling, and each of the PUCCH resource included in the indicated set of PUCCH resource is respectively used for a corresponding UE in the at least one UE.

In an example, the number of the PUCCH resource indications is more than one, and each PUCCH resource indication is respectively used to indicate the PUCCH resource for transmitting the HARQ-ACK information by the corresponding UE among the at least one UE.

In an example, the number of the PUCCH resource indications is more than one, and each PUCCH resource indication is respectively used to indicate the set of PUCCH resource for transmitting the HARQ-ACK information by a corresponding UE group among the at least one UE.

In an example, the PUCCH resource indication includes a PUCCH resource indication (PRI) field.

In an example, the value of the PUCCH resource indication further indicates that some of the at least one UE do not need to transmit the HARQ-ACK information.

In an example, PUCCH candidate resources are determined through a higher layer signaling configuration; and the physical uplink control channel (PUCCH) resource for transmitting the HARQ-ACK information is determined from the PUCCH candidate resources according to the PUCCH resource indication.

In an example, a transmission power control (TPC) command is included in the DCI, and the method further comprises: determining whether to apply the TPC command according to a time unit where the DCI is located.

In an example, a plurality of transmission power control (TPC) commands are further included in the DCI, and each of the plurality of TPC commands corresponds to a corresponding UE and/or a corresponding UE group among the at least one UE.

In an example, parameters for power control of the PUCCH transmitting the HARQ-ACK for the multicast PDSCH are configured separately from parameters for power control of the PUCCH transmitting the HARQ-ACK for the unicast PDSCH.

In an example, the DCI further includes a plurality of downlink allocation indexes (DAIs), which are respectively used to count HARQ-ACK transmitted by the corresponding UE in the at least one UE.

In an example, the DCI further includes an enable field for at least one of: enabling or disabling the PUCCH resource; enabling or disabling the PUCCH resource indication; enabling or disabling the TPC command; and enabling or disabling the DAI.

In an example, the DCI is divided into a first part of DCI and a second part of DCI, the first part of DCI is transmitted on the physical downlink control channel (PDCCH), and the second part of DCI is transmitted on the multicast physical downlink shared channel (PDSCH) scheduled by the PDCCH and includes at least one of the PUCCH resource indication, the TPC command and the DAI.

In an example, an enable field is included in the first part of the DCI, and the enable field is used for at least one of: enabling or disabling the PUCCH resource; enabling or disabling the PUCCH resource indication; enabling or disabling the TPC command; and enabling or disabling the DAI.

In an example, the TPC command field indicates whether to transmit the HARQ-ACK.

In an example, a DCI format indication field in the DCI is used as a PUCCH resource enable/disable field to indicate whether to transmit the HARQ-ACK.

In an example, a value of a downlink data to uplink acknowledgement field in the DCI includes a value indicating no transmitting of the HARQ-ACK.

In an example, the method further comprises: determining a maximum retransmission number for the HARQ-ACK of the same multicast physical downlink shared channel (PDSCH).

In an example, the method further comprises: receiving information of a time window for the multicast PDSCH; and receiving the multicast PDSCH according to the information.

According to another aspect of the embodiments of the present disclosure, a device for transmitting is provided, comprising: a transceiver for transmitting and receiving signals; a processor; and a memory for storing instructions executable by the processor, and when the instructions are executed by the processor, causing the processor to execute any of the aforementioned methods for transmitting.

According to another aspect of the embodiment of the present disclosure, a device for receiving is provided, comprising: a transceiver for transmitting and receiving signals; a processor; and a memory for storing instructions executable by the processor, and when the instructions are executed by the processor, causing the processor to execute any of the aforementioned methods for receiving.

Further, in this application, the method for transmitting the HARQ-ACK for the multicast PDSCH is described, so that the HARQ-ACK feedback information for multicast PDSCH can be accurately transmitted by as few PUCCH resources as possible in the reasonable power on a premise that the multicast technology can save PDSCH and PDCCH.

### BRIEF DESCRIPTION OF DRAWINGS

The present disclosure will be more easily understood through the following detailed description in conjunction with the accompanying drawings, in which the same reference number refers to the same unit, in which:

FIG. 1 shows a schematic diagram of the starting position of the PUSCH in the frequency domain;

FIG. 2 is a flowchart showing an exemplary method of uplink transmission according to an embodiment of the present disclosure;

FIG. 3 shows a schematic diagram of PUSCH frequency hopping starting positions according to an embodiment of the present disclosure;

FIG. 4 shows a schematic diagram of determining an order of PUSCH frequency hopping starting positions according to an embodiment of the present disclosure;

FIG. 5 shows a schematic diagram of OFDM symbols in a DBPG according to an embodiment of the present disclosure;

FIG. 6 shows a schematic diagram of joint channel estimation for DMRS in PUSCH;

FIG. 7 shows a schematic diagram of DBPG frequency hopping starting position when the number of symbols contained in DBPG is the same according to an embodiment of the present disclosure;

FIG. 8 shows a schematic diagram of DBPG frequency hopping starting position when the number of symbols contained in the DBPG is different according to an embodiment of the present disclosure;

FIG. 9 shows a schematic diagram of PUSCH frequency hopping starting positions among different uplink active BWPs according to an embodiment of the present disclosure;

FIG. 10 is a flowchart showing an exemplary method of uplink transmission according to an embodiment of the present disclosure;

FIG. 11 shows a flowchart of an exemplary method of uplink transmission according to an embodiment of the present disclosure;

FIG. 12 shows a flowchart of an exemplary method of uplink transmission according to an embodiment of the present disclosure;

FIG. 13 shows a flowchart of an exemplary method of uplink transmission according to an embodiment of the present disclosure;

FIG. 14 shows a flowchart of an exemplary method of uplink transmission according to an embodiment of the present disclosure;

FIG. 15 shows a flowchart of an exemplary method of uplink transmission according to an embodiment of the present disclosure;

FIG. 16 shows a flowchart of an exemplary method for transmitting HARQ-ACK according to an embodiment of the present disclosure;

FIG. 17 shows a flowchart of an exemplary method for receiving HARQ-ACK according to an embodiment of the present disclosure;

FIG. 18 shows a schematic diagram of an example in which the UE feeds back the HARQ-ACK;

FIG. 19 shows a schematic diagram of another example in which the UE feeds back the HARQ-ACK;

FIG. 20 shows a schematic flowchart of a method for transmitting hybrid automatic repeat request-acknowledgement (HARQ-ACK) information according to an embodiment of the present disclosure;

FIG. 21 shows a schematic diagram of an example in which DCI is divided into two parts according to an embodiment of the present disclosure;

FIG. 22 shows a schematic diagram of a HARQ-ACK transmission method for a multicast PDSCH;

FIG. 23 shows a schematic diagram of a HARQ-ACK transmission method for the multicast PDSCH according to an embodiment of the present disclosure;

FIG. 24 shows a schematic diagram in which different UEs feed back the HARQ-ACK information through the same PUCCH resource;

FIG. 25 shows a schematic diagram of a multicast PDSCH within a time window according to an embodiment of the present disclosure;

FIG. 26 shows a schematic diagram of a multicast PDSCH within a time window and a multicast PDSCH outside the time window according to an embodiment of the present disclosure;

FIG. 27 shows a schematic diagram of a method for receiving hybrid automatic repeat request-acknowledgement (HARQ-ACK) information according to an embodiment of the present disclosure;

FIG. 28 shows a schematic block diagram of a device for transmitting according to an embodiment of the present disclosure; and

FIG. 29 shows a schematic block diagram of a device for receiving according to an embodiment of the present disclosure.

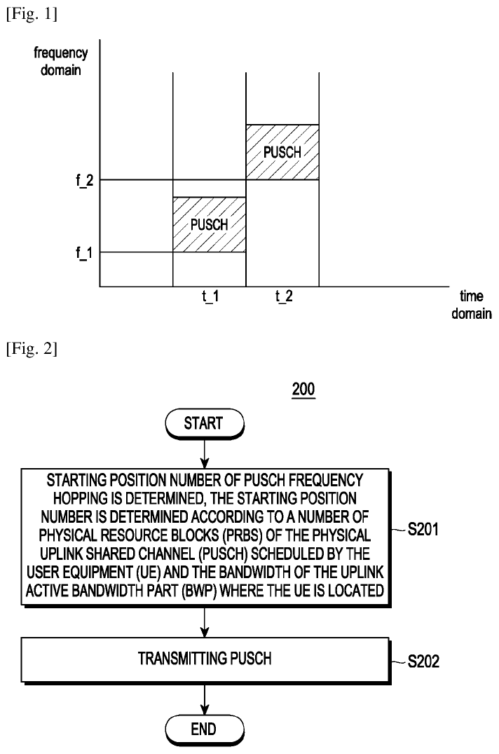

### MODE FOR THE INVENTION

In order to make the purpose, technical solution and advantages of the present disclosure more clear, various exemplary embodiments of the present disclosure are described below the accompanying drawings to further describe the present disclosure in detail.

The example embodiments described herein are not meant to be limiting. The aspects of the present disclosure as generally described herein and shown in the drawings may be arranged, replaced, combined, separated, and designed in various different configurations, all of which may be considered herein. In addition, the features shown in each drawing may be used in combination with each other, unless the context dictates otherwise. Therefore, the drawings should generally be regarded as an integral part of one or more overall embodiments, but it should be understood that not all the illustrated features are necessary for each embodiment.

In order to improve the frequency diversity of the PUSCH, the PUSCH transmission can use a frequency hopping method, and there are 2 starting positions of PUSCH transmitted in the frequency domain, for example, the frequency hopping starting positions are f_1 and f_2. Also, there may be more than 2 frequency hopping starting positions, for example, there are 4 starting positions of PUSCH transmitted in the frequency domain, for example, the frequency hopping starting positions are f_1, f_2, f_3, and f_4. The number of the frequency hopping starting positions is related to the bandwidth that the UE can work on, for example, when the frequency hopping range of the UE is the active BWP (Active Bandwidth Part) where the UE is located, the number of the frequency hopping starting positions is related to the bandwidth of the active BWP where the UE is located. The frequency hopping range of the UE is the sum of the range of the frequency band that can be occupied by the UE for multiple frequency hopping. Alternatively, when the frequency hopping range of the UE is the carrier where the UE is located, the number of starting positions is related to the bandwidth of the carrier where the UE is located.

In this description, the PUSCH is taken as an example for description, but the method herein can also be applied to physical uplink control channel (PUCCH) or sidelink transmission transmitted by the UE. The PUSCH is taken as an example for description below.

Since the UE may be at an edge of the cell, an uplink transmission power of the UE is limited, and the number of physical resource blocks (PRBs) which can be scheduled by the UE is limited. At this time, if the number of the frequency hopping starting positions is determined according to the bandwidth that the UE can work on, the effect of the frequency diversity effect of frequency hopping cannot be well. For example, the bandwidth of the uplink active BWP where the UE is located is 40 PRBs, and if the bandwidth of the uplink active BWP is 40 PRBs, there are 2 starting points for the frequency hopping of the uplink active BWP for the UE, for example, the first PRB and the twenty-first PRB. However, since the UE is at the edge of the cell at this time, according to the maximum transmit power requirements of UE, PUSCH of the UE can schedule up to 10 PRBs. At this time, there are only 2 starting points of frequency hopping, that is, PUSCH transmission of the UE is performed from the 1st PRB to the 10th PRB and from the 21st PRB to the 30th PRB, but not from the 11th to the 20th PRB and from the 31st to the 40th PRB, through frequency hopping. As a result, the frequency diversity gain is not fully utilized.

According to the embodiment of the present disclosure, in order to give full play to the frequency diversity effect of frequency hopping, the number of PUSCH frequency hopping starting positions may not be completely determined by the bandwidth of the uplink active BWP, which will be described in detail with reference to the accompanying drawings.

FIG. 2 is a flowchart showing an exemplary method 200 of uplink transmission according to an embodiment of the present disclosure. The method 200 can be implemented on the UE side.

As shown in FIG. 2, in method 200, at S201, the number of PUSCH frequency hopping starting positions is determined, and the number of starting positions is determined according to a number of physical resource blocks (PRBs) of physical uplink shared channel (PUSCH) scheduled by a user equipment (UE) and a bandwidth of an uplink active bandwidth part (BWP) where the UE is located.

At S202, the PUSCH is transmitted.

Therefore, according to the embodiment of the present disclosure, the frequency diversity gain of the uplink transmission can be improved based on the frequency hopping method of the uplink transmission, by determining the frequency hopping method of the uplink transmission, thereby improving the transmission performance of the uplink and increasing the coverage of the uplink.

Hereinafter, various examples for determining the number of PUSCH frequency hopping starting positions based on the number of PRBs of the PUSCH to be scheduled by the UE and the bandwidth of the uplink active BWP where the UE is located will be described in detail with reference to the accompanying drawings.

According to the embodiment of the present disclosure, the steps S201 and S202 may also be performed simultaneously on the base station side, which will be described in detail later.

First Implementation

In the First Implementation, the base station may inform the UE of the number of PUSCH frequency hopping starting positions through high-level signaling after the base station determines the number of PUSCH frequency hopping starting positions.

The advantage of this method is that the base station can determine the appropriate number of PUSCH frequency hopping starting positions according to the number of PRBs of PUSCH that can be scheduled by the UE and the bandwidth of the uplink active BWP where the UE is located, and informs the UE through high-level signalling, for example, the UE knows that the number of PUSCH frequency hopping starting positions is 4 by receiving higher layer signalling, or the UE knows that the number of PUSCH frequency hopping starting positions is 2 by receiving higher layer signalling.

Second Implementation

In the Second Implementation, multiple candidate configurations for the number of PUSCH frequency hopping starting positions may be determined. For example, the multiple candidate configurations for the number of PUSCH frequency hopping starting positions may be determined in advance through protocols or predetermined rules, and then the base station may determine the number of the starting positions of one PUSCH frequency hopping as the number of the starting positions of the current PUSCH frequency hopping according to the number of PRBs of PUSCH that can be scheduled by the UE and the bandwidth of the uplink active BWP where the UE is located, and informs the UE through high-level signalling. In an example, one or more candidate configurations for the number of the starting position may correspond to the bandwidth of the same uplink active BWP.

For example, as shown in Table 1, there are two configurations for the number of PUSCH frequency hopping starting positions, namely, Configuration 1 and Configuration 2, which correspond to the bandwidth of the same uplink active BWP, and correspond to different number of PUSCH frequency hopping starting positions. In table 1, L1, L2, M1, and M2 respectively represent different number of PUSCH frequency hopping starting positions. Table 1 represents a number of PUSCH frequency hopping starting positions.

TABLE 1

| uplink active BWP handwidth | | |
|---|---|---|
| (number of PRBs) | Configuration 1 | Configuration 2 |
| less than or equal to 50 | L1 | M1 |
| more than 50 | L2 | M2 |

In an example, the UE may receive the bandwidth of the uplink active BWP where the UE is located from the base station, and receive an indication information transmitted by the base station, and then determine the number of PUSCH frequency hopping starting positions from multiple candidate for the number of PUSCH frequency hopping starting positions according to the bandwidth and indication information. The indication information may be determined by the base station according to the number of PRBs of the PUSCH scheduled by the UE.

For example, the base station can know that the number of PUSCH frequency hopping starting positions is Configuration 1 in Table 1 through an indication information, such as high-level signaling, and then determine the number of the starting position of the current PUSCH frequency hopping is L1 according to the number of PUSCH PRBs that can be scheduled by the UE such as “less than or equal to 50”.

The advantage of this method is that the base station can determine the appropriate number of PUSCH frequency hopping starting positions according to the number of PRBs of PUSCH that can be scheduled by the UE and the bandwidth of the uplink active BWP where the UE is located, and informs the UE through high-level signalling, for example, the UE knows that the number of PUSCH frequency hopping starting positions is Configuration 1 in Table 1 by receiving higher layer signalling.

Third Implementation

In the Third Implementation, the multiple candidate configurations for the number of PUSCH frequency hopping starting positions may be determined by a protocol, and then the base station may determine the number of the starting positions of one PUSCH frequency hopping as the number of the starting positions of the current PUSCH frequency hopping according to the number of PRBs of PUSCH that can be scheduled by the UE and the bandwidth of the uplink active BWP where the UE is located, and may inform the UE through media access layer signalling or physical layer signalling, in which the physical layer signalling may be indicated by the bit information in downlink control information (DCI) for scheduling PUSCH, for example, as shown in Table 1, there are two configurations for the number of PUSCH frequency hopping starting positions, namely, Configuration 1 and Configuration 2, which correspond to the bandwidth of the same uplink active BWP, and correspond to different number of PUSCH frequency hopping starting positions.

A specific implementation method of the signaling is as follows.

Format 0_1

An indication for the number of the frequency hopping starting positions—n bits, n is a natural number. The number of bits of the indication for the number of the frequency hopping starting positions is determined according to the configuration for the number of PUSCH frequency hopping starting positions in the uplink active BWP. For example, there are two configurations for the number of PUSCH frequency hopping starting positions, the indication for the number of the frequency hopping starting positions is 1 bit. For example, when the value of indication for the number of the frequency hopping starting positions is “0”, the number of PUSCH frequency hopping starting positions is Configuration 1, and when the value of indication for the number of the frequency hopping starting positions is “1”, the number of PUSCH frequency hopping starting positions is Configuration 2.

The advantage of this method is that the base station can determine the appropriate number of PUSCH frequency hopping starting positions according to the number of PRBs of PUSCH that can be scheduled by the UE and the bandwidth of the uplink active BWP where the UE is located, and informs the UE through media access layer signaling or physical layer signaling, so as to select the more appropriate number of PUSCH frequency hopping starting positions in a more timely manner.

Fourth Implementation

In the Fourth Implementation, the number of PUSCH frequency hopping starting positions may be determined according to both of the number of PRBs of PUSCH scheduled and the number of PRBs of the uplink active BWP, and may be determined at the base station side and the UE side at the same time, without additional signalling to inform the UE of the number of PUSCH frequency hopping starting positions.

Assuming that the number of PRBs of PUSCH to be scheduled by the UE is L, and the bandwidth of the uplink active BWP where the UE is located is M, the number of PUSCH frequency hopping starting positions can be determined based on the following formula: Floor └M/L┘, wherein, Floor └·┘ represents a round-down operation.

Table 2 shows a specific example. As shown in Table 2, when Floor └M/L┘ is greater than or equal to r1, the number of PUSCH frequency hopping starting positions is L1, and when Floor └M/L┘ is less than r1 and greater than or equal to r2, the number of PUSCH frequency hopping starting positions is L2, and when Floor └M/L┘ is less than r2, the number of PUSCH frequency hopping starting positions is L3. The values of r1 and r2 can be set as needed

For example, assuming that M is equal to 40, r1 is equal to 4, r2 is equal to 2, L1 is equal to 4, L2 is equal to 2, and L3 is equal to 1. When L is equal to 9, Floor └M/L┘=Floor └40/9┘=4=r1, the number of PUSCH frequency hopping starting positions is L1=4; when L is 15, Floor └M/L┘=Floor └40/15┘=2<r1, and Floor └M/L┘=Floor └40/15┘=2=r2, the number of PUSCH frequency hopping starting positions is L2=2; when L is 25, Floor └M/L┘=Floor └40/25 ┘=1<r2, the number of PUSCH frequency hopping starting positions is L3=1.

Table 2: number of PUSCH frequency hopping starting positions

TABLE 2

| | number of PUSCH frequency |
|---|---|
| relationship between L and M | hopping starting positions |
| Floor └M/L┘ more than or equal to R1 | L1 |
| Floor └M/L┘ more than or equal to r2 and | L2 |
| Floor └M/L┘ less than r1 | |
| Floor └M/L┘ less than r2 | L3 |

wherein, the relationship among L1, L2 and L3 may be: L3<=L2<=L1

The advantage of this method is that the base station can determine the number of PUSCH frequency hopping starting positions according to the PRB number of PUSCH actually scheduled by the UE and the PRB number of the uplink active BWP where the UE is located, without additional signaling to inform the UE, so as to select the appropriate number of PUSCH frequency hopping starting positions in time.

Fifth Implementation

In the Fifth Implementation, the base station may inform the UE of multiple number of PUSCH frequency hopping starting positions in an implicit manner. An index value of Time Domain Resource Assignment (TDRA) information in Downlink Control Information (DCI) for scheduling PUSCH may be used for indication.

For example, as shown in Table 3, there are three configurations for the number of PUSCH frequency hopping starting positions, namely, Configuration 1, Configuration 2, and Configuration 3. Assuming that the number of PUSCH frequency hopping starting positions in Configuration 1 is h_1 the number of PUSCH frequency hopping starting positions in Configuration 2 is h_2 the number of PUSCH frequency hopping starting positions in Configuration 3 is h_3, for example, h_1 is equal to 4, h_2 is equal to 2, and h_3 is equal to 1. However, Table 3 is only exemplary, and those skilled in the art can understand that there can be more or less than three configurations of the number of PUSCH frequency hopping starting positions.

Table 3: PUSCH TDRA Table

TABLE 3

| | | | | | number of PUSCH |
|---|---|---|---|---|---|
| TDRA | PUSCH | | | | frequency hopping |
| index | mapping type | K₂ | S | L | starting positions |
| 1 | Type A | j | 0 | 14 | h_1 |
| 2 | Type A | j | 0 | 12 | h_1 |
| 3 | Type A | j | 0 | 10 | h_1 |
| 4 | Type B | j | 2 | 10 | h_1 |
| 5 | Type B | j | 4 | 10 | h_1 |
| 6 | Type B | j | 4 | 8 | h_2 |
| 7 | Type B | j | 4 | 6 | h_2 |
| 8 | Type A | j + 1 | 0 | 14 | h_2 |
| 9 | Type A | j + 1 | 0 | 12 | h_2 |
| 10 | Type A | j + 1 | 0 | 10 | h_2 |
| 11 | Type A | j + 2 | 0 | 14 | h_3 |
| 12 | Type A | j + 2 | 0 | 12 | h_3 |
| 13 | Type A | j + 2 | 0 | 10 | h_3 |
| 14 | Type B | j | 8 | 6 | h_3 |
| 15 | Type A | j + 3 | 0 | 14 | h_3 |
| 16 | Type A | j + 3 | 0 | 10 | h_3 |

For example, when the index value of TDRA information is one of 1 to 5, it indicates that the number of PUSCH frequency hopping starting positions is h_1; when the index value of TDRA information is one of 6 to 10, it indicates that the number of PUSCH frequency hopping starting positions is h_2; and when the index value of the TDRA information is one of 11 to 16, it indicates that the number of PUSCH frequency hopping starting positions is h_3.

In Table 3, S represents the starting symbol number, L represents the symbol length, and K2 represents the transmission-reception time offset of the signal.

The advantage of this method is to determine the number of PUSCH frequency hopping starting positions according to the situation of UE, and then indicate through the TDRA information, without additional signalling to inform the UE, so as to select the appropriate number of PUSCH frequency hopping starting positions in time.

According to the embodiment of the present disclosure, the foregoing PUSCH may be a single PUSCH or PUSCH repetition, that is, the time unit of PUSCH frequency hopping may be one PUSCH or one PUSCH repetition. In addition, the PUSCH described above may also be a PUSCH group. For example, the PUSCH described above may be a PUSCH group composed of multiple PUSCHs using joint channel estimation.

When there is more than one PUSCH frequency hopping starting position, that is, the number of PUSCH frequency hopping starting positions is greater than 2, and there are multiple PUSCH transmissions, determining the order of PUSCH frequency hopping starting positions is a problem that needs to be solved in each PUSCH transmission.

The PUSCH frequency hopping operation is to increase the effect of frequency diversity of PUSCH transmission. In the multiple transmissions (repetitive transmission) of PUSCH, the difference among different PUSCH transmissions in the frequency domain is maximized, so that the frequency diversity has a greater effect, but the number of PUSCH repetitions that transmit the same data information may be more or less. When the number of PUSCH repetitive transmissions is less, the purpose of determining the different PUSCH frequency hopping starting positions is to maximize the difference among different PUSCH transmissions in the frequency domain.

The determination of PUSCH frequency hopping starting positions may be performed on at least one of the base station side and the UE side.

One method for determining the different PUSCH frequency hopping starting positions may be to determine an order of PUSCH frequency hopping starting positions according to a descending order of offsets among PUSCH frequency hopping starting positions. For example, the offset of PUSCH frequency hopping starting position of the first transmission is 0, the PUSCH frequency hopping starting position of the second transmission is a PUSCH frequency hopping start position with the offset being the maximum of all the offsets, and so on.

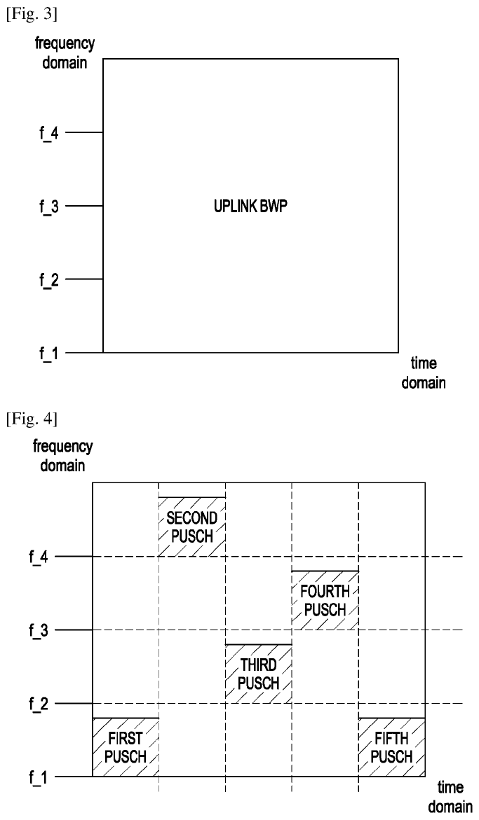

FIG. 3 shows a schematic diagram of PUSCH frequency hopping starting positions according to an embodiment of the present disclosure.

As shown in FIG. 3, there are 4 PUSCH frequency hopping starting positions and 3 offset positions, the first PUSCH frequency hopping starting position f_1 has an offset of 0, and the offset of the second PUSCH frequency hopping starting position f_2 relative to the start position of the first PUSCH frequency hopping is offset_1, the offset of the third PUSCH frequency hopping starting position f_3 relative to the start position of the first PUSCH frequency hopping is offset_2, the offset of the forth PUSCH frequency hopping starting position f_3 relative to the start position of the first PUSCH frequency hopping is offset_4.

FIG. 4 shows a schematic diagram of determining the order of PUSCH frequency hopping starting positions according to an embodiment of the present disclosure.

Continuing the example in FIG. 3, in order to maximize the gain of frequency hopping, as shown in FIG. 4, the offset of PUSCH frequency hopping starting position of the i-th transmission is 0, the offset of PUSCH frequency hopping starting position of the i+1-th transmission is the maximum value of offset_1, offset_2, and offset_3, that is, max{offset_1, offset_2, offset_3}. For example, offset_1=2/4 BWP bandwidth, offset_2=1/4 BWP bandwidth, offset_3=3/4 BWP bandwidth, then max{offset_1, offset_2, offset_3}=3/4 BWP bandwidth, so the offset of PUSCH frequency hopping starting position of the i+1-th transmission is 3/4 BWP bandwidth, that is, PUSCH frequency hopping starting position is f_4. Then, the offset of the starting position of the PUSCH frequency hopping of the i+2-th transmission is the maximum value of the remaining offsets, that is, max{offset_1, offset_2}=2/4 BWP bandwidth, that is, the PUSCH frequency hopping starting position is f_2. The offset of the starting position of the PUSCH frequency hopping of the i+3-th transmission is offset_2, that is, PUSCH frequency hopping starting position is f_3. If there is i+4-th transmission, its PUSCH frequency hopping starting position can be f_1 again, and so on.

Here, i is an integer, for example, i=1.

The advantage of using this method is that when the number of frequency hopping is relatively small, the UE can obtain the maximum frequency diversity gain and increase the performance of the PUSCH.

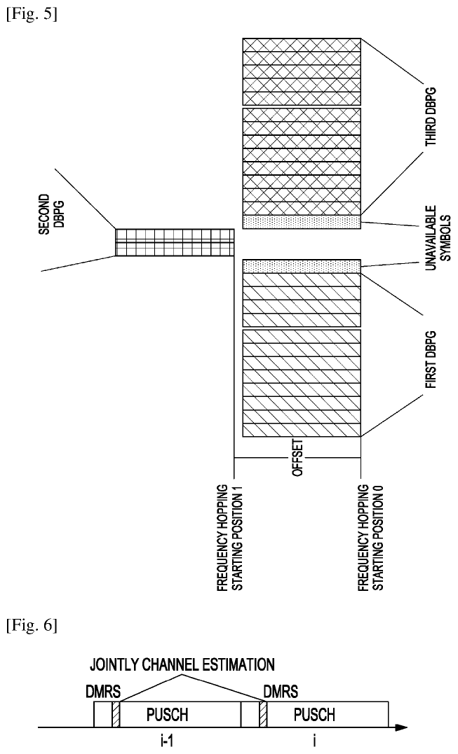

FIG. 5 shows a schematic diagram of OFDM symbols in a DBPG according to an embodiment of the present disclosure.

FIG. 6 shows a schematic diagram of joint channel estimation for DMRS in PUSCH.

In order to improve the accuracy of channel estimation based on Demodulation Reference Signal (DMRS), joint channel estimation can be performed based on DMRSs in multiple of more than one PUSCH transmission time, that is, at least two PUSCH transmission time, so that channels can increase the accuracy of channel estimation, thereby improving the bit error rate performance of PUSCH demodulation. Multiple (i.e. at least one) PUSCH or PUSCH repetition for joint channel estimation is called DMRS Bundling PUSCH Group (DBPG). Since PUSCH in DMRS bundled PUSCH group is continuous, that is, there is no unusable OFDM symbol or downlink OFDM symbol segment in the middle, but the appearance of unusable OFDM symbols is not regular, this will cause the number of OFDM symbols in different DBPGs to be unequal, or even very different.

For example, as shown in FIG. 5, the first DBPG includes 12 OFDM symbols, the second DBPG includes 2 OFDM symbols, the third DBPG includes 13 OFDM symbols, and there are 2 frequency hopping starting positions. At this time, the offset of DBPG frequency hopping start position of the first transmission is 0, the offset of the DBPG frequency hopping start position of the second transmission is “offset”, and the offset of the DBPG frequency hopping of the third transmission start position is 0, so that the first DBPG and the third DBPG whose offset of starting position is 0 have totally 25 OFDM symbols, and the second DBPG whose offset of starting position is offset has 2 OFDM symbols. In this way, most of transmission time is at the frequency domain position where the offset of starting position is 0, and the transmission time at the frequency domain position whose offset of starting position is offset is very little. If the PUSCH transmitted at the frequency domain position where offset of starting position is 0 and PUSCH transmitted at the frequency domain position whose offset of starting position is offset are jointly decoded, the frequency diversity gain is not significant.

According to the embodiment of the present disclosure, in order to ensure the frequency diversity gain of PUSCH frequency hopping, in another method of determining the order of PUSCH frequency hopping start positions, the number of OFDM symbols in the DBPG can be considered, that is, the order of PUSCH frequency hopping start positions is determined based on the number of OFDM symbols contained in DBPG.

Thereafter, a method of determining the order of PUSCH frequency hopping starting positions in consideration of the number of OFDM symbols in DBPG to improve the frequency diversity gain of frequency hopping according to an embodiment of the present disclosure will be specifically described.

Sixth Implementation

In the Sixth Implementation, the DBPG frequency hopping starting position is determined according to the number of symbols contained in the DBPG. For example, the DBPG frequency hopping starting position may be sequentially selected in a descending order of the number of symbols contained in DBPG.

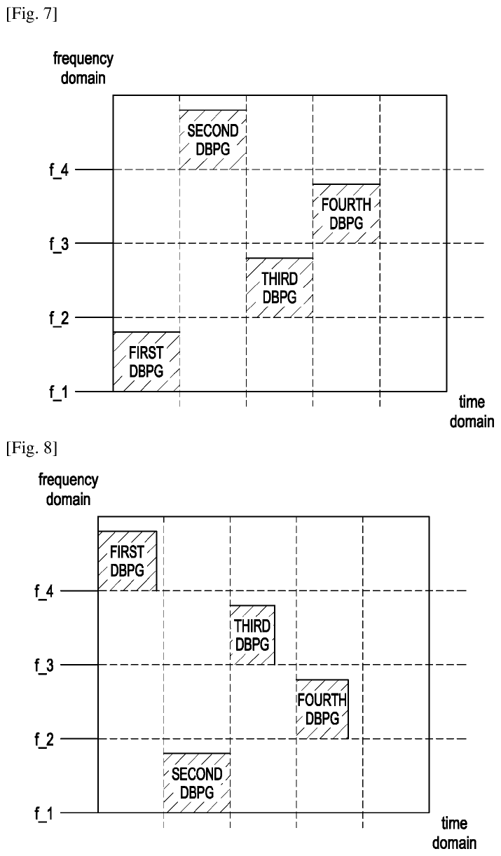

FIG. 7 shows a schematic diagram of DBPG frequency hopping starting position when the number of symbols contained in DBPG is the same according to an embodiment of the present disclosure.

As shown in FIG. 7, if the number of symbols contained in multiple DBPGs is the same, the order of DBPG frequency hopping starting positions can be determined according to the time order of the DBPG. For example, there are 4 DBPG frequency hopping starting positions, namely, f_1, f_2, f_3, and f_4, and the number of symbols contained in the DPBG is the same. In this case, assuming that the order of DBPG frequency hopping starting positions can be: f_1->f_4->f_2->f_3, that is, the DBPG frequency hopping starting position of the first transmission is f_1, and the DBPG frequency hopping starting position of the second transmission is f_4, the DBPG frequency hopping starting position of the third transmission is f_2, and the DBPG frequency hopping starting position of the fourth transmission is f_3.

FIG. 8 shows a schematic diagram of DBPG frequency hopping starting position when the number of symbols contained in the DBPG is different according to an embodiment of the present disclosure.

As shown in FIG. 8, if the number of symbols contained in multiple DBPGs is different, the DBPG frequency hopping starting positions f_1->f_4->f_2->f_3 may be selected in the descending order of the number of symbols contained in the DBPG. Here, still assuming that at the beginning, the order of DBPG frequency hopping starting positions is: f_1->f_4->f_2->f_3. Assuming that the number of OFDM symbols contained in DBPG of the first transmission is L1, the number of OFDM symbols contained in DBPG of the second transmission is L2, the number of OFDM symbols contained in DBPG of the third transmission is L3, the number of OFDM symbols contained in DBPG of the fourth transmission is L4, and L2>L1>L4>L3, it then may be determined that the DBPG frequency hopping starting position of the second transmission is f_1, and the DBPG frequency hopping starting position of the first transmission is f_4, the DBPG frequency hopping starting position of the fourth transmission is f_2, and the DBPG frequency hopping starting position of the third transmission is f_3.

The advantage of this method is that when the number of frequency hopping is relatively small, the UE can obtain the maximum frequency diversity gain and increase the performance of the PUSCH.

Seventh Implementation

In the Seventh Implementation, when the number of OFDM symbols contained in one DBPG is less than a threshold number, the DBPG frequency hopping starting position is the same as a previous DBPG frequency hopping starting position or a next DBPG frequency hopping starting position.

For example, when the number of OFDM symbols contained in one DBPG is less than S1 preset by a protocol or configured by higher level signalling (for example, S1 is a positive integer equal to 1, or 2, or 3, etc.), the DBPG uses the same value as the previous DBPG frequency hopping starting position or the next DBPG frequency hopping starting position. For example, S1 is equal to 3, and when the number of OFDM symbols contained in one DBPG is less than 3, the DBPG uses the same starting position of frequency hopping as the DBPG preceding the DBPG. For example, there are 4 frequency hopping starting positions, namely, f_1, f_2, f_3, and f_4, and the order of DBPG frequency hopping is f_1->f_4->f_2->f_3. Assuming there are 4 DPBG transmissions, the number of OFDM symbols contained in DBPG of the first transmission is 12, the number of OFDM symbols contained in DBPG of the second transmission is 2, the number of OFDM symbols contained in DBPG of the third transmission is 7, and the number of OFDM symbols contained in DBPG of the forth transmission is 8. Therefore, according to the example 2, the DBPG frequency hopping start position of the first transmission is f_; the number of OFDM symbols contained in DBPG of the second transmission is 2, which is less than 3, then the DBPG frequency hopping start position of the second transmission is the same as DBPG frequency hopping start position of the first transmission, which is f_1; the DBPG frequency hopping start position of the third transmission is f_4, and the DBPG frequency hopping start position of the forth transmission is f_2.

Here, although it is described that when the number of OFDM symbols contained in DBPG is less than the threshold number, DBPG frequency hopping starting position is the same as the immediately previous DBPG frequency hopping starting position or the immediately next DBPG frequency hopping starting position, but the embodiment of the present disclosure is not limited thereto. DBPG frequency hopping starting position is the same as one of the previous DBPG frequency hopping starting positions or one of the next DBPG frequency hopping starting positions.

The advantage of this method is that when the number of symbols contained in DBPG is relatively small, the UE can obtain a relatively large frequency diversity gain and increase the performance of the PUSCH.

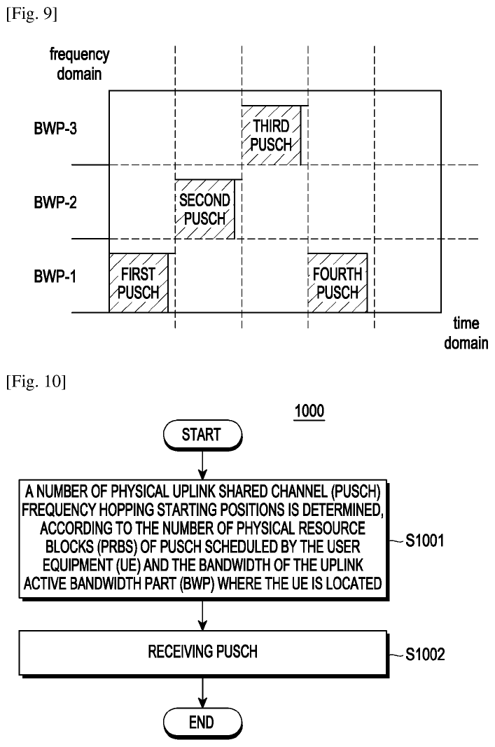

FIG. 9 shows a schematic diagram of PUSCH frequency hopping starting positions among different uplink active BWPs according to an embodiment of the present disclosure.

According to the embodiment of the disclosure, PUSCH frequency hopping starting position may be in the same uplink active BWP or in different uplink active BWPs

As mentioned above, PUSCH frequency hopping is a frequency hopping within the active BWP configured by the UE, so there is no need to adjust the time among different hopping frequencies. If the bandwidth capability of the UE is limited, in order for the UE to obtain a relatively large frequency diversity gain, the frequency hopping operation among BWPs can be used, that is, the transmission of the PUSCH performs frequency hopping operation among different BWPs in a certain order.

For example, if one PUSCH needs to be repeatedly transmitted 3 times, and the UE performs frequency hopping among 3 BWPs, that is, the first PUSCH repetition is transmitted on BWP-1, the second PUSCH repetition is transmitted on BWP-2, and the third PUSCH is transmitted on BWP-3, as shown in FIG. 9, and there are intervals among the different PUSCH transmissions for adjusting. In addition, when the PUSCH frequency hops to a BWP, the BWP becomes the active BWP, and the UE sends the PUCCH or detects PDCCH candidates on the BWP. When the frequency hopping ends, one solution is that the UE automatically returns to the initial active BWP. As shown in FIG. 9, after the third PUSCH repetition transmission on BWP-3 ends, the active BWP becomes the BWP-1 at the beginning of PUSCH repetition transmission. Another solution is that the UE make the BWP where the last transmitted PUSCH is located as active BWP. After the third PUSCH repetition transmission on the BWP-3 ends, the active BWP becomes BWP-3 at the end of PUSCH repetition transmission.

The advantage of this method is that when the bandwidth capability of the UE is limited, the UE can obtain a relatively large frequency diversity gain and increase the performance of the PUSCH. According to the embodiment of the present disclosure, it can indicate whether the UE to use the frequency hopping within the BWP or the frequency hopping among BWPs through high-level signalling configuration or physical layer signalling, so that the frequency diversity gain and the resource occupation of the interval required for frequency hopping among BWPs can be balanced.

FIG. 10 is a flowchart showing an exemplary method 1000 of uplink transmission according to an embodiment of the present disclosure. The method 1000 may be implemented on the base station side.

As shown in FIG. 10, in method 1000, at 51001, the number of physical uplink shared channel (PUSCH) frequency hopping starting positions is determined, according to the number of physical resource blocks (PRBs) of PUSCH scheduled by the user equipment (UE) and the bandwidth of the uplink active bandwidth part (BWP) where the UE is located.

At S1002, PUSCH is received.

Therefore, according to the embodiment of the present disclosure, the frequency diversity gain of the uplink transmission can be improved based on the frequency hopping method of the uplink transmission by determining the frequency hopping method of the uplink transmission, thereby improving the transmission performance of the uplink and increasing the coverage of the uplink.

The specific method for determining the number of PUSCH frequency hopping starting positions on the base station side is similar to that described above for the UE side, and will not be repeated here.

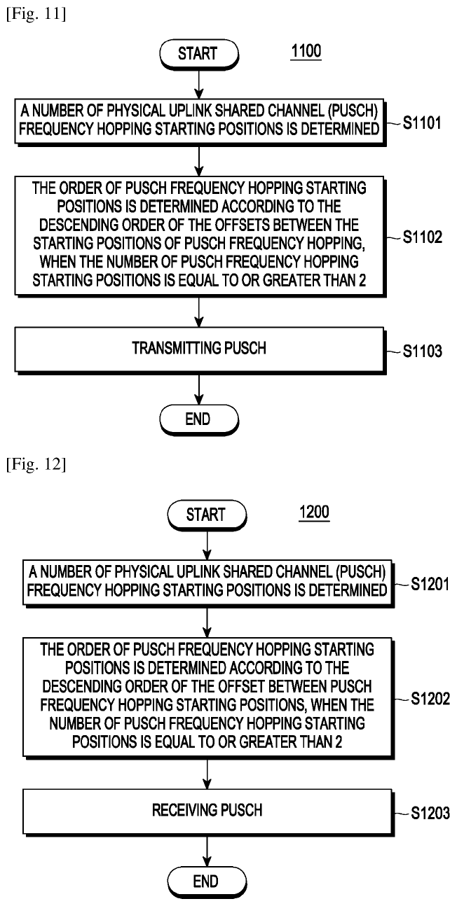

FIG. 11 shows a flowchart of an exemplary method 1100 of uplink transmission according to an embodiment of the present disclosure. The method 1100 may be implemented on the UE side.

As shown in FIG. 11, in method 1100, at S1101, the number of physical uplink shared channel (PUSCH) frequency hopping starting positions is determined. At S1102, the order of PUSCH frequency hopping starting positions is determined according to the descending order of the offset among the PUSCH frequency hopping starting positions, when the number of PUSCH frequency hopping starting positions is equal to or greater than 2. At S1103, the PUSCH is transmitted.

FIG. 12 shows a flowchart of an exemplary method 1200 of uplink transmission according to an embodiment of the present disclosure. The method 1200 may be implemented on the base station side.

As shown in FIG. 12, in method 1200, at S1201, the number of physical uplink shared channel (PUSCH) frequency hopping starting positions is determined. At S1202, the order of PUSCH frequency hopping starting positions is determined according to the descending order of the offset among the PUSCH frequency hopping starting positions, when the number of PUSCH frequency hopping starting positions is equal to or greater than 2. At S1203, the PUSCH is transmitted.

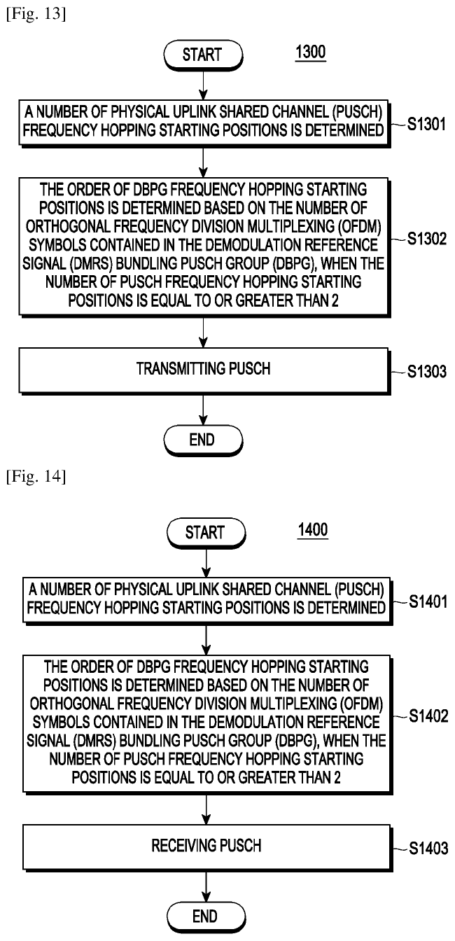

FIG. 13 shows a flowchart of an exemplary method 1300 of uplink transmission according to an embodiment of the present disclosure. The method 1300 may be implemented on the UE side.

As shown in FIG. 13, in method 1300, at S1301, the number of physical uplink shared channel (PUSCH) frequency hopping starting positions is determined. At S1302, the order of demodulation reference signal (DMRS) bundling PUSCH group (DBPG) frequency hopping starting positions is determined based on a number of orthogonal frequency division multiplexing (OFDM) symbols contained in the DBPG, when the number of PUSCH frequency hopping starting positions is equal to or greater than 2. At S1303, the PUSCH is transmitted.

In an example, when the number of OFDM symbols contained in multiple DBPGs is the same, the order of DBPG frequency hopping starting positions is determined according to the time order of DBPG.

In an example, when the number of OFDM symbols contained in multiple DBPGs is different, the order of DBPG frequency hopping starting positions is determined according to the descending order of the number of symbols contained in the DBPG.

In an example, when the number of OFDM symbols contained in one DBPG is less than the threshold number, DBPG frequency hopping starting position is the same as the previous DBPG frequency hopping starting position or the next DBPG frequency hopping starting position.

FIG. 14 shows a flowchart of an exemplary method 1400 of uplink transmission according to an embodiment of the present disclosure. The method 1400 can be implemented on the base station side.

As shown in FIG. 14, in method 1400, at S1401, the number of physical uplink shared channel (PUSCH) frequency hopping starting positions is determined. At S1402, the order of demodulation reference signal (DMRS) bundling PUSCH group (DBPG) frequency hopping starting positions is determined based on a number of orthogonal frequency division multiplexing (OFDM) symbols contained in the DBPG, when the number of PUSCH frequency hopping starting positions is equal to or greater than 2. At S1403, the PUSCH is received.

In an example, when the number of OFDM symbols contained in multiple DBPGs is the same, the order of DBPG frequency hopping starting positions is determined according to the time order of DBPG.

In an example, when the number of OFDM symbols contained in multiple DBPGs is different, the order of DBPG frequency hopping starting positions is determined according to the descending order of the number of symbols contained in the DBPG.

In an example, when the number of OFDM symbols contained in one DBPG is less than the threshold number, DBPG frequency hopping starting position is the same as the previous DBPG frequency hopping starting position or the next DBPG frequency hopping starting position.

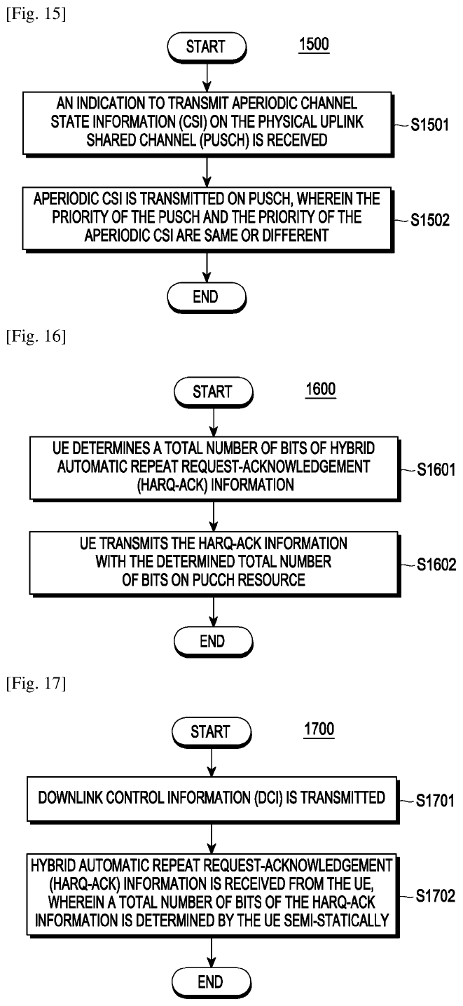

FIG. 15 shows a flowchart of an exemplary method 1500 of uplink transmission according to an embodiment of the present disclosure. The method 1500 can be implemented on the UE side.

As shown in FIG. 15, in method 1500, at S1501, an indication to transmit aperiodic channel state information (CSI) on a physical uplink shared channel (PUSCH) is received. At S1502, the aperiodic CSI is transmitted on the PUSCH, wherein a priority of the PUSCH and a priority of the aperiodic CSI are same or different.

According to the embodiment of the present disclosure, there are Physical Uplink Shared Channel (PUSCH, Physical Uplink Shared Channel) with high priority and PUSCH with low priority. The PUSCH with high priority is called as a first priority PUSCH, and the PUSCH with low priority is called as a second priority PUSCH. The Channel State Information (CSI) may also be classified into CSI with high-priority and CSI with low-priority. The CSI with high-priority is called as a first-priority CSI, and the CSI with low-priority is called as a second-priority CSI.

The aperiodic CSI may be driven by the CSI Request field in the DCI for scheduling PUSCH. A priority of the aperiodic CSI may be determined according to the priority of the PUSCH transmitting aperiodic CSI, that is, if the priority of the PUSCH transmitting aperiodic CSI is the first priority PUSCH, the aperiodic CSI is a first priority CSI, and if the priority of the PUSCH transmitting the aperiodic CSI is the second priority PUSCH, the aperiodic CSI is a second priority CSI. With this method, the driving of aperiodic CSI with different priorities is not flexible, and the base station may not be able to obtain the aperiodic CSI with the required priority in time.

According to the embodiment of the present disclosure, a DCI for scheduling PUSCH may be introduced to drive the aperiodic CSI with a priority different from the priority of PUSCH transmitting the aperiodic CSI. For example, the priority of PUSCH transmitting aperiodic CSI is the second priority PUSCH, but the first priority aperiodic CSI may be driven, and the priority of the PUSCH transmitting aperiodic CSI is the first priority PUSCH, but the second priority aperiodic CSI can be driven. A detailed description is given below.

Eighth Implementation

In the Eighth Implementation, the priority of the driven aperiodic CSI may be indicated by including a bit in the DCI for scheduling PUSCH.

For example, in the DCI for scheduling PUSCH, the field indicating the priority of the driven aperiodic CSI is n bits, and n is a natural number, for example, n=1 (1 bit is an example and can be extended to 2 bits, 3 bits, etc.). When the field value is “0”, the driven aperiodic CSI is the first priority aperiodic CSI, and when the field value is “1”, the driven aperiodic CSI is the second priority aperiodic CSI.

Alternatively, the field indicating the priority of the driven aperiodic CSI is 2 bits, when the field value is “00”, the driven aperiodic CSI is the first priority aperiodic CSI, when the field value is “01”, The driven aperiodic CSI is the second priority aperiodic CSI, when the field value is “10”, the driven aperiodic CSI is the first priority aperiodic CSI and the second priority aperiodic CSI, and when the value is “11”, it is a reserved field.

The advantage of this method is that the base station can flexibly select the priority aperiodic CSI which is required.

Ninth Implementation

In the Ninth Implementation, the priority of aperiodic CSI driven by DCI may be indicated through implicit signalling. For example, a correspondence relationship between the priority of the aperiodic CSI to be transmitted and the value of the CSI request information is set, and the implicit signalling may be the value of the CSI request information in the DCI for scheduling PUSCH, as indicated by the following fields.

Format 0_1

CSI request—0, 1, 2, 3, 4, 5, or 6 bits, the number of bits is determined according to the parameter reportTriggerSize configured by higher layer signaling.

The priority of the aperiodic CSI driven by DCI may be determined by the CSI request information. For example, assuming that the CSI request has 2 bits, the corresponding relationship between the CSI request information value and the CSI report configuration and the priority of the driven aperiodic CSI is shown in Table 4. Alternatively, the corresponding relationship between the CSI request information value and the CSI report configuration and the priority of the driven aperiodic CSI is shown in Table 5.

Table 4: the corresponding relationship between the CSI request information value and the CSI report configuration and the priority of the driven aperiodic CSI

TABLE 4

| CSI request | | |
|---|---|---|
| information | aperiodic CSI report | |
| value | configuration | priority of aperiodic CSI |
| 00 | no aperiodic CSI report | No |
| 01 | aperiodic CSI configuration 1 | the first priority aperiodic |
| | configured by higher level | CSI |
| | signalling | |
| 10 | aperiodic CSI configuration 2 | the second priority aperiodic |
| | configured by higher level | CSI |
| | signalling | |
| 11 | aperiodic CSI configuration 3 | the first priority aperiodic |
| | configured by higher level | CSI and the second priority |
| | signalling | aperiodic CSI |

In another example, the corresponding relationship between the CSI request information value and the CSI report configuration and the priority of the driven aperiodic CSI may be as shown in Table 5, wherein the priority configuration 1 of the aperiodic CSI configured by higher level signaling, the priority configuration 2 of the aperiodic CSI configured by higher layer signaling and the priority configuration 3 of the aperiodic CSI configured by higher layer signaling may only include the first priority aperiodic CSI, or may only include the second priority aperiodic CSI, and may also include both the first priority aperiodic CSI and the second priority aperiodic CSI.

Table 5: the corresponding relationship between the CSI request information value and the CSI report configuration and the priority of the driven aperiodic CSI

TABLE 5

| CSI request | | |
|---|---|---|
| information | aperiodic CSI report | |
| value | configuration | priority of aperiodic CSI |
| 00 | no aperiodic CSI report | No |
| 01 | aperiodic CSI configuration 1 | priority configuration 1 of |
| | configured by higher level | aperiodic CSI configured by |
| | signalling | high level signalling |
| 10 | aperiodic CSI configuration 2 | priority configuration 2 of |
| | configured by higher level | aperiodic CSI configured by |
| | signalling | high level signalling |
| 11 | aperiodic CSI configuration 3 | priority configuration 3 of |
| | configured by higher level | aperiodic CSI configured by |
| | signalling | high level signalling |

The advantage of this method is that the base station can flexibly select the aperiodic CSI with the required priority, without additional physical layer signaling overhead.

FIG. 16 shows a flowchart of an exemplary method 1600 for transmitting HARQ-ACK according to an embodiment of the present disclosure. The method 1600 may be implemented at the UE side.

As shown in FIG. 16, in the method 1600, at S1601, the UE determines a total number of bits of hybrid automatic repeat request-acknowledgement (HARQ-ACK) information. At S1602, the UE transmits the HARQ-ACK information with the determined total number of bits on PUCCH resource.

According to the present embodiment, at S1601, the total number of bits of the HARQ-ACK information transmitted by the UE may be determined semi-statically. Further, at S1602, the UE determining the number of bits of the HARQ-ACK information may comprise: receiving, by the UE, configuration information on the number of bits of the HARQ-ACK information; and determining the number of bits of the HARQ-ACK information according to the configuration information, wherein the configuration information is a semi-static configuration information.

That is to say, if the UE configures pdsch-HARQ-ACK-Codebook=semi-static, then it may be considered that the UE configures a Typle-1 HARQ-ACK codebook.

If a counter DL Downlink Assignment Index (DAI) domain exists in the DCI scheduling the PDCCH of PDSCH (for example, the format of DCI is DCI format 1_0), the number of bits of the HARQ-ACK information for the UE may be determined semi-statically be the higher layer signaling (Type-1 HARQ-ACK codebook).

For example, m serving cells are configured for the UE, a bundling window of each serving cell is s (the bundling windows of respective serving cells may also be different, and the same bundling window is described as an example herein), that is, each serving cell has the HARQ-ACK feedback information of s downlink slots to be transmitted on one uplink slot. Namely, a set composed of all downlink slots requiring or maybe requiring to feedback the HARQ-ACK information on one uplink time unit n, for example, a subframe and/or slot, etc., comprises m*s downlink slots of m serving cells. The number of bit of each HARQ-ACK information per downlink slot per serving cell is d, then the total number of bits of the HARQ-ACK information for the PUCCH transmission on one uplink slot is m*s*d bits, as shown in following equation (1).

The total number of bits of the HARQ-ACK information to be transmitted=a number of serving cells*bundling window per cell*a number of bits of each HARQ-ACK information Equation(1)

Assuming that m=4, s=4, d=1, then q=m*s*d=4*4*1=16, m, s and d are all natural numbers.

In one case, the UE receives a configuration information on the number of bits of the HARQ-ACK information and receives the DAI, and determines the total number q of bits of the HARQ-ACK information to be transmitted according to the count DL DAI. Particularly, in these m=4 serving cells, if UE definitely knows that the base station may transmit the PDSCH or PDCCH indicating Semi-Persistent Scheduling (SPS) releasing on one downlink slot in the primary serving cell, for example, when UE receives only the PDSCH with the count DL DAI being equal to 1, which is scheduled by the PDCCH, UE feeds back the HARQ-ACK information for the PDSCH or for the PDCCH indicating SPS releasing, and determines the number q of bits of the HARQ-ACK information for the PDSCH or the PDCCH indicating SPS releasing according to a transmission mode of the serving cell. For example, when the transmission mode of the serving cell supports the transmission with one transport block, q=1, and when the transmission mode of the serving cell supports the transmission with two transport blocks, q=2.

In other cases, the number of bits of the HARQ-ACK information to be transmitted is determined according to the above equation (1), that is, is equal to 16.

According to embodiments of the present disclosure, the number of bits of the HARQ-ACK information to be transmitted may be determined further based on PDSCH configured for the UE.

The UE may be configured to receive two types of PDSCHs, called as a first type PDSCH and a second type PDSCH. For example, the first type PDSCH may be a unicast PDSCH which is scheduled by a DCI with C-RNTI scrambled CRC, and the second type PDSCH may be a multicast PDSCH which is scheduled by a DCI with GRNTI scrambled CRC, and the DAIs in the DCIs scheduling the two types of PDSCHs are counted separately. At this time, UE may receive a DAI1 in the DCI scheduling the first type PDSCH and a DAI2 in the DCI scheduling the second type PDSCH simultaneously, and the DAI1 may be equal to 1 while the DAI2 is equal to 1.

For the first type PDSCH and the second type PDSCH, UE may be configured of respective two sets of PUCCH resources or only one sets of PUCCH resources.

Transmission of HARQ-ACK information when UE is configured of two sets of PUCCH resources

When two sets of PUCCH resources are configured for the UE, one set of PUCCH resource configuration is used for transmitting the HARQ-ACK information for the first type PDSCH and called as the first set PUCCH resource, and the other set of PUCCH resource configuration is used for transmitting the HARQ-ACK information for the second type PDSCH and called as the second set PUCCH resource. There may be four methods for determining the total number of bits of HARQ-ACK information to be transmitted as follows.

Method 1

When the UE receives only one first type PDSCH (for example, the UE receives the PDSCH in the primary cell) and the DAI1 in the DCI1 scheduling the PDSCH (for example, the format of this DCI is DCI format 1_0) is equal to 1, the UE feeds back the HARQ-ACK information only for the PDSCH in the first set of PUCCH resource. The total number of bits of the HARQ-ACK information to be transmitted may be determined according to the transmission mode of the serving cell.

When the UE receives only one second type PDSCH (for example, the UE receives the PDSCH in the primary cell) and the DAI2 in the DCI2 scheduling the PDSCH (for example, the format of this DCI is DCI format 1_0) is equal to 1, the UE feeds back the HARQ-ACK information only for the PDSCH in the second set of PUCCH resource. The total number of bits of the HARQ-ACK information to be transmitted may be determined according to the transmission mode of the serving cell.

When the UE receives more than one PDSCHs, or receives the PDSCH but the DAI in the DCI scheduling the PDSCH is not equal to 1, or receives the PDSCH but no DAI indication exists in the DCI scheduling the PDSCH, the total number of bits of the HARQ-ACK information to be fed back by the UE is determined according to the above equation (1).

With this method, it can save the PUCCH resource when the UE receives only one PDSCH and the DAI in the DCI scheduling the PDSCH is equal to 1.

Method 2

When the UE receives only one first type PDSCH (for example, the UE receives the PDSCH in the primary cell) and the DAI1 in the DCI1 scheduling the PDSCH (for example, the format of this DCI is DCI format 1_0) is equal to 1, the UE feeds back the HARQ-ACK information only for the PDSCH in the first set of PUCCH resource. The total number of bits of the HARQ-ACK information to be transmitted may be determined according to the transmission mode of the serving cell.

When the UE receives only one second type PDSCH (for example, the UE receives the PDSCH in the primary cell) and the DAI2 in the DCI2 scheduling the PDSCH (for example, the format of this DCI is DCI format 1_0) is equal to 1, or when the UE receives more than one PDSCHs, or receives the PDSCH but the DAI in the DCI scheduling the PDSCH is not equal to 1, or receives the PDSCH but no DAI indication exists in the DCI scheduling the PDSCH, the total number of bits of the HARQ-ACK information to be fed back by the UE is determined according to the above equation (1).

With this method, it can save the PUCCH resource when the UE receives only one first type PDSCH and the DAI in the DCI scheduling the PDSCH is equal to 1.

Method 3

When the UE receives only one second type PDSCH (for example, the UE receives the PDSCH in the primary cell) and the DAI2 in the DCI1 scheduling the PDSCH (for example, the format of this DCI is DCI format 1_0) is equal to 1, the UE feeds back the HARQ-ACK information only for the PDSCH in the second set of PUCCH resource. The total number of bits of the HARQ-ACK information to be transmitted may be determined according to the transmission mode of the serving cell.

When the UE receives only one first type PDSCH (for example, the UE receives the PDSCH in the primary cell) and the DAI1 in the DCI1 scheduling the PDSCH (for example, the format of this DCI is DCI format 1_0) is equal to 1, or when the UE receives more than one PDSCHs, or receives the PDSCH but the DAI in the DCI scheduling the PDSCH is not equal to 1, or receives the PDSCH but no DAI indication exists in the DCI scheduling the PDSCH, the total number of bits of the HARQ-ACK information to be fed back by the UE is determined according to the above equation (1).

With this method, it can save the PUCCH resource when the UE receives only one second type PDSCH and the DAI in the DCI scheduling the PDSCH is equal to 1.

Method 4

When the UE receives only one first type PDSCH or only one second type PDSCH (for example, the UE receives the PDSCH in the primary cell) and the DAI in the DCI scheduling the PDSCH (for example, the format of this DCI is DCI format 1_0) is equal to 1, or when the UE receives more than one PDSCHs, or receives the PDSCH but the DAI in the DCI scheduling the PDSCH is not equal to 1, or receives the PDSCH but no DAI indication exists in the DCI scheduling the PDSCH, the total number of bits of the HARQ-ACK information to be fed back by the UE is determined according to the above equation (1).

Above described several methods for determining the number of bits of the HARQ-ACK information, and UE may also determine one of the above methods for determining the number of bits of HARQ-ACK information according to higher layer signaling configuration.

Transmission of HARQ-ACK information when UE is configured of one sets of PUCCH resources

When one set of PUCCH resources are configured for the UE, the set of PUCCH resource is configured to transmit the HARQ-ACK information for the first type PDSCH and the HARQ-ACK information for the second type PDSCH. There may be three methods for determining the total number of bits of HARQ-ACK information to be transmitted as follows.

Method 1

When the UE receives only one first type PDSCH (for example, the UE receives the PDSCH in the primary cell) and the DAI1 in the DCI1 scheduling the PDSCH (for example, the format of this DCI is DCI format 1_0) is equal to 1, the UE feeds back the HARQ-ACK information only for the PDSCH on the PUCCH resource. The total number of bits of the HARQ-ACK information to be transmitted may be determined according to the transmission mode of the serving cell.

When the UE receives only one second type PDSCH (for example, the UE receives the PDSCH in the primary cell) and the DAI2 in the DCI2 scheduling the PDSCH (for example, the format of this DCI is DCI format 1_0) is equal to 1, or when the UE receives more than one PDSCHs, or receives the PDSCH but the DAI in the DCI scheduling the PDSCH is not equal to 1, or receives the PDSCH but no DAI indication exists in the DCI scheduling the PDSCH, the total number of bits of the HARQ-ACK information to be fed back by the UE is determined according to the above equation (1).

With this method, it can save the PUCCH resource when the UE receives only one first type PDSCH and the DAI in the DCI scheduling the PDSCH is equal to 1. Additionally, with this method, the UE and the base station would not misunderstand whether the first type PDSCH or the second type PDSCH the HARQ-ACK information is used for.

Method 2

When the UE receives only one second type PDSCH (for example, the UE receives the PDSCH in the primary cell) and the DAI2 in the DCI2 scheduling the PDSCH (for example, the format of this DCI is DCI format 1_0) is equal to 1, the UE feeds back the HARQ-ACK information only for the PDSCH on the PUCCH resource. The total number of bits of the HARQ-ACK information to be transmitted may be determined according to the transmission mode of the serving cell.

When the UE receives only one first type PDSCH (for example, the UE receives the PDSCH in the primary cell) and the DAI1 in the DCI1 scheduling the PDSCH (for example, the format of this DCI is DCI format 1_0) is equal to 1, or when the UE receives more than one PDSCHs, or receives the PDSCH but the DAI in the DCI scheduling the PDSCH is not equal to 1, or receives the PDSCH but no DAI indication exists in the DCI scheduling the PDSCH, the total number of bits of the HARQ-ACK information to be fed back by the UE is determined according to the above equation (1).

With this method, it can save the PUCCH resource when the UE receives only one second type PDSCH and the DAI in the DCI scheduling the PDSCH is equal to 1.

Method 3

When the UE receives only one first type PDSCH or only one second type PDSCH (for example, the UE receives the PDSCH in the primary cell) and the DAI in the DCI scheduling the PDSCH (for example, the format of this DCI is DCI format 1_0) is equal to 1, or when the UE receives more than one PDSCHs, or receives the PDSCH but the DAI in the DCI scheduling the PDSCH is not equal to 1, or receives the PDSCH but no DAI indication exists in the DCI scheduling the PDSCH, the total number of bits of the HARQ-ACK information to be fed back by the UE is determined according to the above equation (1).

Above described several methods for determining the number of bits of the HARQ-ACK information, and UE may also determine one of the above methods for determining the number of bits of HARQ-ACK information according to higher layer signaling configuration.

FIG. 17 shows a flowchart of an exemplary method 1700 for receiving HARQ-ACK according to an embodiment of the present disclosure. The method 1700 may be implemented at the base station side.

As shown in FIG. 17, at S1701, downlink control information (DCI) is transmitted. At S1702, the hybrid automatic repeat request-acknowledgement (HARQ-ACK) information is received from the UE, wherein a total number of bits of the HARQ-ACK information is determined by the UE semi-statically.

In an example, the total number of bits of the HARQ-ACK information to be transmitted=a number of serving cells*bundling window per cell*a number of bits of each HARQ-ACK information.

In an example, the total number of bits of the HARQ-ACK information transmitted by the UE is determined based on a count downlink (DL) assignment index (DAI) in a downlink control information (DCI) in a PDCCH scheduling the PDSCH.

In an example, the total number of bits of the HARQ-ACK information to be transmitted is determined according to a transmission mode of the serving cell, when the DAI is equal to 1.

A HARQ-ACK transmission method of the multicast PDSCH will be described below.

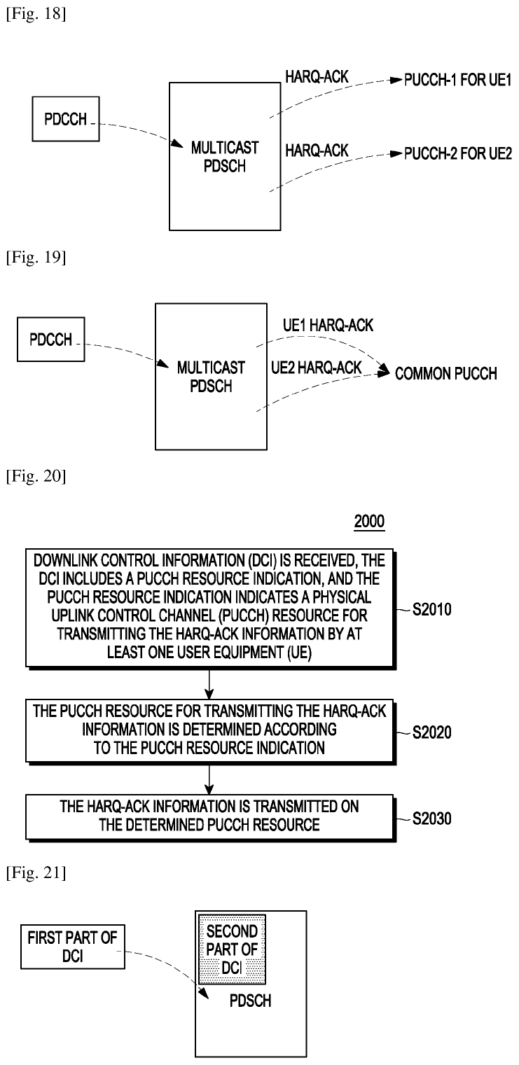

FIG. 18 shows a schematic diagram of an example in which the UE feeds back HARQ-ACK.

The multicasted PDSCH is scheduled by Downlink Control Information (DCI) in a Common Search Space (CSS), and is received by at least two UEs. As shown in FIG. 18, different UEs may use different PUCCH resources to feed back their respective HARQ-ACKs, and the UE may feed back ACK if it decodes the PDSCH correctly, and may feed back NACK if it does not decode the PDSCH correctly.

FIG. 19 shows a schematic diagram of another example in which the UE feeds back HARQ-ACK.

Alternatively, the different UEs may also use a same PUCCH resource to feed back the HARQ-ACK, and the UE may feed back no HARQ-ACK information if it decodes the PDSCH correctly, and may feed back NACK on the PUCCH resources if it receives the PDCCH but does not decode the PDSCH correctly. The PUCCH resource is shared by multicast UEs, and all multicast UEs feed back the HARQ-ACK on the shared PUCCH resource, as shown in FIG. 19.

When the different UEs use different PUCCH resources to feed back their respective HARQ-ACKs or the different UEs use the same PUCCH resource to feed back their respective HARQ-ACKs, the PUCCH resource for transmitting the HARQ-ACK for the multicast PDSCH by each UE, the transmission power control (TPC) command of the PUCCH and the downlink allocation index (DAI) may be determined by various methods according to the embodiments of the present disclosure, or at least one of the above methods may be selected through higher layer signaling configuration.

Hereinafter, the embodiments of the present disclosure will be described in detail with reference to the drawings.

Tenth Implementation

According to the Tenth Implementation of the embodiment of the present disclosure, the PUCCH resource for transmitting the HARQ-ACK for the multicast PDSCH may be determined.

FIG. 20 shows a schematic flowchart of a method 2000 for transmitting hybrid automatic repeat request-acknowledgement (HARQ-ACK) information according to an embodiment of the present disclosure. The method 2000 may be implemented on the user equipment (UE) side.

As shown in FIG. 20, in the method 2000, at step S2010, downlink control information (DCI) is received, the DCI includes a PUCCH resource indication, and the PUCCH resource indication indicates a physical uplink control channel (PUCCH) resource for transmitting the HARQ-ACK information by at least one user equipment (UE).

At step S2020, the PUCCH resource for transmitting the HARQ-ACK information is determined according to the PUCCH resource indication.

At step S2030, the HARQ-ACK information is transmitted on the determined PUCCH resource. Therefore, according to the embodiments of the present disclosure, the HARQ-ACK feedback information for multicast PDSCH can be accurately transmitted by as few PUCCH resources as possible in the reasonable power on a premise that the multicast technology can save PDSCH and PDCCH.

Hereinafter, various examples of the 10th implementation manner according to the embodiment of the present disclosure will be described in detail with reference to the accompanying drawings.

Example 10.1

The PUCCH resource may be indicated by the PUCCH resource indication in the DCI scheduling the multicast PDSCH, for example, indicated by one field in the DCI, which may be called a resource indication field, such as a PRI (PUCCH Resource Indication) field, this field may indicate one set of PUCCH resource among multiple sets of PUCCH resource configured by higher layer signaling, and each set of PUCCH resource contains N_i (N_i is a positive integer) PUCCH resources, and i is an index of the set of PUCCH resource. A plurality of (i.e, N_i) PUCCH resources in each set of PUCCH resources may be used for at least one UE respectively.

That is, PUCCH candidate resources and/or sets of PUCCH candidate resources are determined through the higher layer signaling configuration, and the physical uplink control channel (PUCCH) resource used for transmitting the HARQ-ACK information is determined from the PUCCH candidate resources and/or the sets of PUCCH candidate resources according to the PUCCH resource indication, such as the PRI field.

For example, the PRI may comprise 2 bits, and may indicate 4 sets of PUCCH resources totally, as shown in Table 6. This method is advantageous in that the UE could allocate the PUCCH resources for transmitting the HARQ-ACK for the multicast PDSCH for each UE with fewer physical layer information bits. The PRI of 2 bits is just an example, and those skilled in the art could understand that the PRI may include fewer or more bits to indicate fewer or more sets of PUCCH resources.

Table 6: Correspondence between PRI value and the set of PUCCH resource

TABLE 6

| PRI | |
|---|---|
| value | Set of PUCCH resource |
| 00 | Set 1 of PUCCH resource configured by higher layer signaling |
| 01 | Set 2 of PUCCH resource configured by higher layer signaling |
| 10 | Set 3 of PUCCH resource configured by higher layer signaling |
| 11 | Set 4 of PUCCH resource configured by higher layer signaling |

In an example, a number of PUCCH resources in each set of PUCCH resources may be the same. In this case, all N_i are the same, for example, N. In the case of Table 6, for example, N_1=N_2=N_3=N_4=N. The UE may obtain the value of N by receiving the higher layer signaling configuration.

In another example, the numbers of PUCCH resources in each of sets of PUCCH resources may be different, and the UE may obtain the value N_i of the number of PUCCH resource in the set i of PUCCH resource by receiving the higher layer signaling configuration.

According to the embodiment of the present disclosure, each UE in the at least one UE uses one PUCCH resource in the indicated set of PUCCH resource to feed back the HARQ-ACK, and the PUCCH resource used by each UE may be obtained according to the corresponding relationship between the index of the UE and the PUCCH resource index in the set of PUCCH resource, or may be obtained by receiving the higher layer signaling configuration.

Example 10.2

Alternatively, the PUCCH resource may be indicated by M PRI fields in the DCI scheduling the multicast PDSCH, where M is a positive integer, and each PRI field is respectively used to indicate the PUCCH resource for transmitting the HARQ-ACK information by the corresponding UE in the at least one UE. That is, each PRI field indicates one PUCCH resource among the plurality of PUCCH resources configured by the higher layer signaling, and each UE transmits the HARQ-ACK by the indicated PUCCH resource respectively.

The UE may obtain a value of M by receiving the higher layer signaling configuration, and the UE may also obtain an index of the PRI field indicating the PUCCH resource for transmitting the HARQ-ACK information by the UE by receiving the higher layer signaling configuration. For example, the PRI with the field index of m is a PRI field indicating the PUCCH resource for transmitting the HARQ-ACK information for the multicast PDSCH by the UE with the UE index of UE-m.

For example, each PRI may comprise 2 bits, and may indicate 4 PUCCH resources totally, as shown in Table 7. This method is advantageous in that the plurality of PRI fields could be used to indicate the PUCCH resources for each UE independently and flexibly. Similarly, the PRI of 2 bits is just an example, and those skilled in the art can understand that the PRI may include fewer or more bits to indicate fewer or more sets of PUCCH resources.

Table 7: Correspondence between PRI value and the PUCCH resource

TABLE 7

| PRI | |
|---|---|
| value | PUCCH resource |
| 00 | PUCCH resource 1 configured by higher layer signaling |
| 01 | PUCCH resource 2 configured by higher layer signaling |
| 10 | PUCCH resource 3 configured by higher layer signaling |
| 11 | PUCCH resource 4 configured by higher layer signaling |

Example 10.3

Alternatively, as shown in Table 8, the indicated PUCCH resource may include an item that some UEs in the at least one UE do not need to transmit the HARQ-ACK.

Tis method is advantageous in that, if the UE needs not to feed back the HARQ-ACK, it may indicate that the UE does not to feed back HARQ-ACK by the item of not needing to transmit the HARQ-ACK, which can save the PUCCH resources and the power of UE. Similarly, each PRI of 2 bits is just an example, and those skilled in the art can understand that the PRI may include fewer or more bits to indicate fewer or more sets of PUCCH resource.

Table 8: Correspondence between PRI value and the PUCCH resource

TABLE 8

| PRI | |
|---|---|
| value | PUCCH resource |
| 00 | No need to transmit HARQ-ACK |
| 01 | PUCCH resource 1 configured by higher layer signaling |
| 10 | PUCCH resource 2 configured by higher layer signaling |
| 11 | PUCCH resource 3 configured by higher layer signaling |

Example 10.4

Alternatively, the PUCCH resource may be indicated by M PRI fields in the DCI scheduling the multicast PDSCH, M is a positive integer, and each PRI field is respectively used to indicate the set of PUCCH resources for transmitting the HARQ-ACK information by the corresponding UE group in the at least one UE. That is, each PRI field indicates one set of PUCCH resources among the plurality of sets of PUCCH resources configured by the higher layer signaling, as shown in Table 9, and the UE obtains the PRI field index indicating the set of PUCCH resources for transmitting the HARQ-ACK information by the UE by receiving the higher layer signaling configuration. For example, the PRI with the field index of m is the PRI field indicating the set of PUCCH resources for transmitting the HARQ-ACK information by the UE group where the UE with the UE index of UE-m is located, each UE in the UE group uses one PUCCH resource in the indicated set of PUCCH resources to feed back the HARQ-ACK, the PUCCH resource used by the each UE may be obtained according to the corresponding relationship between the index of the UE and the PUCCH resource index in the set of PUCCH resources, or may be obtained by receiving the higher layer signaling configuration.

Different PRI fields are for different UE groups, and the UE obtains the value of M by receiving higher layer signaling configuration. Using this method saves information bits in the DCI, and can independently indicate PUCCH resource for each UE group more flexibly. Similarly, the PRI of 2 bits is just an example, and those skilled in the art can understand that the PRI may include fewer or more bits to indicate fewer or more sets of PUCCH resources.

Table 9: Correspondence between PRI value and the set of PUCCH resources

TABLE 9

| PRI | |
|---|---|
| value | set of PUCCH resource |
| 00 | set 1 of PUCCH resource configured by higher layer signaling |
| 01 | set 2 of PUCCH resource configured by higher layer signaling |
| 10 | set 3 of PUCCH resource configured by higher layer signaling |
| 11 | set 4 of PUCCH resource configured by higher layer signaling |

Example 10.5

Alternatively, as shown in Table 10, the indicated set of PUCCH resources may include an item that some UEs in the at least one UE do not need to transmit the HARQ-ACK.

This method is advantageous in that if all UEs in the group do not need to feed back the HARQ-ACK, it may indicate that the UE group does not to feed back HARQ-ACK with the item of not needing to transmit the HARQ-ACK, which can save the PUCCH resources and the power of UE. Similarly, PRI of 2 bits is just an example, and those skilled in the art can understand that the PRI may include fewer or more bits to indicate fewer or more sets of PUCCH resources.

Table 10: Correspondence between PRI value and the set of PUCCH resource

TABLE 10

| PRI | |
|---|---|
| value | set of PUCCH resource |
| 00 | No need to transmit HARQ-ACK |
| 01 | set 1 of PUCCH resource configured by higher layer signaling |
| 10 | set 2 of PUCCH resource configured by higher layer signaling |
| 11 | set 3 of PUCCH resource configured by higher layer signaling |

In an example, for the PUCCH resource indicated by the PRI in the DCI scheduling the multicast PDSCH, an enable/disable field may be used for enabling or disabling the PUCCH resource indicated by the PRI by newly adding field(s), reinterpreting other fields, and by reserved fields in the DCI.

The enable/disable field may be indicated by a bitmap method, and a number E of bits of the enable/disable field is configured by a higher layer signaling. Each of the E bits used for enabling/disabling the PUCCH resource or the set of PUCCH resources may be configured by the higher layer signaling. For example, when a bit value of one bit in the enable/disable field is “0”, the PUCCH resource or the set of PUCCH resources indicated by this bit does not transmit the HARQ-ACK, and when the bit value is “1”, the PUCCH resource or the set of PUCCH resources indicated by this bit transmits the HARQ-ACK, and vice versa. This method is advantageous in that if the UE or all UEs in the UE group do not need to feed back HARQ-ACK, the enable/disable field could be used to indicate that the UE or the UE group does not feed back HARQ-ACK, which can save PUCCH resources and the power of UE.

Example 10.6

FIG. 21 shows a schematic diagram of an example in which DCI is divided into two parts according to an embodiment of the present disclosure.

As mentioned above, the resource indication field of the PUCCH resource may be located on the downlink control signaling (DCI) in the multicast PDSCH resource. According to the embodiment of the present disclosure, the DCI scheduling the multicast PDSCH may be divided into two parts: one part of the DCI is transmitted in the PDCCH, called as the first part of DCI; and the other part of DCI is transmitted in the multicast PDSCH scheduled by the PDCCH, called as the second part of DCI. The PUCCH resource indicator field may be included in the second part of DCI.

This method is advantageous in that the DCI is divided into two parts. The number of bits in the first part of the DCI may be the same as the number of bits in the DCI scheduling the unicast PDSCH, so that when the UE supports both multicast and unicast, the number of DCIs with different sizes for blind PDCCH detection is not increased, and the PUCCH resources can be indicated more flexibly in the second part of the DCI.

The PUCCH resource indication field included in the second part of the DCI, for example, the PRI field, may indicate the PUCCH resource for transmitting the HARQ-ACK in one of the aforementioned examples 10.1 to 10.5.

In an example, the PUCCH resource may be indicated by one PRI field in the second part of the DCI. This field may indicate one set of PUCCH resources among the plurality of sets of PUCCH resources configured by the higher layer signaling, and each set of PUCCH resources contains N_i (N_i is a positive integer) PUCCH resources, i is the index of the set of PUCCH resources. The plurality of (i.e, N_i) PUCCH resources in each set of PUCCH resources may be used for at least one UE respectively, as shown in Table 6. Each UE in the at least one UE uses one PUCCH resource in the indicated set of PUCCH resources to feed back the HARQ-ACK, and the PUCCH resource used by the each UE may be obtained according to the corresponding relationship between the index of the UE and the PUCCH resource index in the set of PUCCH resources, or may be obtained by receiving the higher layer signaling configuration.

In an example, the PUCCH resource may be indicated by M PRI fields in the second part of the DCI, and M is a positive integer. Each PRI field indicates one PUCCH resource among the plurality of PUCCH resources configured by the higher layer signaling, and the UE obtains the PRI field indicating the PUCCH resource for transmitting the HARQ-ACK by the UE by receiving the high-layer signaling configuration. For example, a field PRI-m is a PRI field indicating the PUCCH resource for transmitting the HARQ-ACK by the UE with the UE index of UE-m. The UE uses the indicated PUCCH resource to transmit the HARQ-ACK, as shown in Table 7. The UE obtains the value of M by receiving the higher layer signaling configuration.

In an example, as shown in Table 8, the indicated set of PUCCH resources may include an item of not needing to transmit the HARQ-ACK, because at this time the UE does not need to feed back the HARQ-ACK, which can save PUCCH resource.

In an example, the PUCCH resource may be indicated by M PRI fields in the second part of the DCI, and M is a positive integer. Each PRI field indicates one set of PUCCH resources among the plurality of sets of PUCCH resources configured by the higher layer signaling, as shown in Table 9. The UE obtains the PRI field indicating the set of PUCCH resources for transmitting the HARQ-ACK by the UE by the receiving higher level signaling configuration. For example, the PRI-m field is the PRI field indicating the PUCCH resource for transmitting the HARQ-ACK by the UE group to which the UE with the UE index of UE-m belongs to, each UE in the UE group uses one PUCCH resource in the indicated set of PUCCH resources to feed back the HARQ-ACK, and the PUCCH resource used by each UE is obtained according to the corresponding relationship between the index of the UE and the PUCCH resource index in the set of PUCCH resources. Different PRI fields are for different UE groups, and the UE may obtain the value of M by receiving the higher layer signaling configuration.

In an example, as shown in Table 10, the indicated set of PUCCH resource may include an item of not needing to transmit HARQ-ACK, because at this time, the group of UEs does not need to feed back HARQ-ACK, which can save PUCCH resource.

In an example, the PRI field in the second part of the DCI may be enabled/disabled by newly added fields, reinterpreted fields and reserved fields in the first part of the DCI. As mentioned above, the enable/disable field can be indicated by a bitmap method. The number E_1 of bits of the enable/disable field is configured by the higher layer signaling or preset by protocols, and each bit of the E_1 bits is used to enable/disable M_5 (M_5 is configured by the higher layer signaling, M_5 is a positive integer) PRI fields.

For example, when the bit value of one bit of the enable/disable field is “0”, the corresponding M_5 PRI fields are not included in the second part of the DCI. At this time, the UE having the PUCCH resource indicated by the PRI field does not transmit the HARQ-ACK, and the number of bits in the second part of the DCI does not include the bits occupied by the M_5 PRI fields. When the bit value is “1”, the second part of the DCI includes the corresponding M_5 PRI fields. At this time, the UE having the PUCCH resource indicated by the PRI field transmits the HARQ-ACK, and the number of bits in the second part of the DCI includes the bits occupied by the M_5 PRI field. Using this method could save the resource occupied by the second part of DCI and save the PUCCH resource.

Eleventh Implementation

The method for transmitting a TPC command of the PUCCH of the HARQ-ACK of the scheduled multicast PDSCH according to the embodiment of the present disclosure will be specifically described below.

Example 11.1

The DCI scheduling multicast PDSCH comprises a TPC command, such as a TPC command field. This command is used for a power control of PUCCH transmitting the HARQ-ACK by one UE. In order to enable the power control for more than one UE, the TPC command in the DCI may be used for different UEs in different time units respectively. According to the embodiment of the present disclosure, whether to apply the TPC command may be determined according to the time unit where the DCI is located.

For example, in a time slot n, the TPC command field is used for the UE with the UE index of UE-m, and in a time slot n+k, the TPC command field is used for the UE with the UE index of UE-p. According to the embodiment of the present disclosure, a detailed example implementation method may be as follows: assuming that the time unit where the DCI is located is L, L mod Q=S, then S is the index of the UE whose TPC command field is used for the power control, where Q is a positive integer and is configured by the higher layer signaling, mod is a modulo operation.

For example, given Q=5, the index of UE-1 is 1 and the index of UE-2 is 2. When L=6, L mod 5=1, the TPC command field at this time unit is used for the power control for UE-1, and when L=7, L mod 5=2, the TPC command field at this time unit is used for the power control for UE-2.

Alternatively, the TPC command field is only used to the UE with a specific indexed, for example, in the used time unit, the TPC command field in the DCI is used for the UE-1.

This method is advantageous in that as many UEs as possible are allowed to obtain the TPC command for power adjustment without increasing the number of bits of the TPC command.

Example 11.2

The DCI scheduling the multicast PDSCH comprises F TPC command fields and each TPC command field is used for the power control of the PUCCH transmitting the HARQ-ACK for the multicast PDSCH by one UE or one UE group, and F is a positive integer.

The UE obtains the value of F by receiving the higher layer signaling configuration, and the UE obtains the TPC command field for the PUCCH transmitting the HARQ-ACK by the UE by receiving the higher layer signaling configuration. For example, the field TPC-m is the TPC command field for the PUCCH transmitting the HARQ-ACK by the UE-m. This method is advantageous in that each UE may use the TPC command to adjust the power in time.

Example 11.3

The TPC command field used for the power control of PUCCH transmitting the HARQ-ACK for the multicast PDSCH is located in the downlink control signaling (DCI) in the PDSCH resource. At this time, the DCI scheduling multicast PDSCH may be divided into two parts: one part of the DCI is transmitted in the PDCCH, called as the first part of the DCI; and the other part of the DCI is transmitted in the multicast PDSCH scheduled by the PDCCH, called as the second part of the DCI, as shown in FIG. 21.

The TPC command field is included in the second part of DCI, and may be transmitted with reference to one of the Example 11.1 and Example 11.2.

For example, according to the method in the Example 11.2, the TPC command field includes F_1 TPC command fields, F_1 is a positive integer, each TPC field is used for the power control of one UE and/or one UE group, and the UE obtains the TPC command field for the PUCCH transmitting the HARQ-ACK by the UE by receiving the higher layer signaling configuration. For example, the field TPC-m is the TPC command field for the PUCCH transmitting the HARQ-ACK by UE-m. The UE uses the TPC command field to control the power of PUCCH transmitting the HARQ-ACK. The UE obtains the value of F_1 by receiving the high-level signaling configuration.

This method is advantageous in that the DCI is divided into two parts. The number of bits in the first part of the DCI may be the same as the number of bits of the DCI scheduling unicast, so that when the UE supports both multicast and unicast, the number of DCIs with different sizes for PDCCH blind detection is not increased, and the TPC command is indicated more flexibly in the second part of the DCI.

In an example, the TPC command field in the second part of the DCI may be enabled/disabled with a newly added field(s), reinterpreted fields and/or reserved fields in the first part of the DCI. The enable/disable field may be indicated by a bitmap method, the bit number F_2 of the enable/disable field is configured by the higher layer signaling, and each bit of the F_2 bits is used to enable/disable F_3 (F_3 is configured by the higher layer signaling, F_3 is a positive integer) TPC command fields. For example, when the bit value of one bit in the enable/disable field is “0”, the corresponding F_3 TPC command fields are not included in the second part of the DCI. When the bit value of the bit is “1”, the corresponding F_3 TPC command fields are included in the second part of the DCI, and this method may save the resources occupied by the second part of the DCI.

In an example, the PRI field and TPC command field in the second part of DCI may be enabled/disabled separately or jointly with a newly added field(s), reinterpreted fields and/or reserved fields in the first part of DCI. The enable/disable field may be indicated by a bitmap method. The bit number F_4 of the enable/disable field is configured by the higher layer signaling, and each bit of the F_4 bits of the enable/disable field is used for enabling/disable F_5 (F_5 is configured by the higher layer signaling, F_5 is a positive integer) PRI fields and F_5 TPC command fields. For example, each bit in the enable/disable field may be used to indicate the enabling/disabling of the PRI field and the TPC command field respectively, or may be combined to indicate the enabling/disabling of the PRI field and the TPC command field collectively.

For example, when the bit value is “0”, the corresponding F_5 PRI fields and F_5 TPC command fields are not included in the second part of DCI, and when the bit value is “1”, the corresponding F_5 PRI field and F_5 TPC command fields are included in the second part of DCI.

This method could save the resource occupied by the second part of the DCI and save the PUCCH resource and the transmission power of the UE.

Example 11.4

The DCI scheduling multicast PDSCH may comprise no TPC command field or the TPC command field in the DCI scheduling multicast PDSCH may be used as reserved bits, or reinterpreted as other fields, for example, used as the enable/disable field of the PUCCH resource.

In one implementation, the TPC command field is reinterpreted to indicate whether to transmit the HARQ-ACK. Assuming that the UE does not feedback the HARQ-ACK if a bit indication value of the TPC command field, or a part of the bits in the TPC command field (for example, one bit in the TPC command field) is a first value (for example, the first value is 0), and feeds back the HARQ-ACK if the bit indication value of the TPC command field, or a part of the bits in the TPC command field (for example, one bit in the TPC command field) is a second value (for example, the second value is 1).

With this method, it is possible to dynamically indicate whether to transmit the HARQ-ACK according to needs, and can save resource for HARQ-ACK transmission.

Alternatively, in another implementation, a DCI format indication field (Identifier for DCI formats) in the DCI scheduling multicast PDSCH may be reinterpreted as a PUCCH resource enable/disable field.

In an example, the DCI format indication field is reinterpreted to indicate whether to transmit the HARQ-ACK. Assuming that the UE does not feed back the HARQ-ACK if the bit indication value of the DCI format indication field is a first value (for example, the first value is 0), and feeds back the HARQ-ACK if the bit indication value of the DCI format indication field is a second value (for example, When the second value is 1).

With this method, it is possible to dynamically indicate whether to transmit the HARQ-ACK according to needs, and can save resource for HARQ-ACK transmission.

Alternatively, in another implementation, a value of a downlink data to uplink acknowledgement (DL-DataToUL-ACK)—also known as K1 indication—field in the DCI scheduling multicast PDSCH includes a value indicating no transmitting of the HARQ-ACK, which is used to indicate that the UE does not feed back the HARQ-ACK, as shown in Table 11.

Table 11: Correspondence between K1 indication field value and the K1 value

TABLE 11

| K1 indication | |
|---|---|
| field value | K1 value |
| 000 | not transmit HARQ-ACK |
| 001 | first K1 value configured by higher layer signaling |
| 010 | second K1 value configured by higher layer signaling |
| 011 | third K1 value configured by higher layer signaling |
| 100 | forth K1 value configured by higher layer signaling |
| 101 | fifth K1 value configured by higher layer signaling |
| 110 | sixth K1 value configured by higher layer signaling |
| 111 | seventh K1 value configured by higher layer signaling |

The power control of the PUCCH transmitting the HARQ-ACK generated by the multicast PDSCH may be performed by using a group-common TPC command.

Since the HARQ-ACK of the unicast PDSCH and the HARQ-ACK of the multicast PDSCH require different transmission reliabilities, parameters of the power control of the PUCCH transmitting the HARQ-ACK for the unicast PDSCH and parameters of the power control of the PUCCH transmitting the HARQ-ACK for the multicast PDSCH may need to be configured independently. The PUCCH transmitting the HARQ-ACK for the unicast PDSCH and the PUCCH transmitting the HARQ-ACK for the multicast PDSCH may be distinguished by the format of the DCI scheduling the PDSCH or may be distinguished by the RNTI for scrambling a CRC of the DCI scheduling the PDSCH.

For example, the CRC of the PDCCH scheduling the unicast PDSCH is scrambled by a C-RNTI, and the CRC of the PDCCH scheduling the multicast PDSCH is scrambled by a MBS-RNTI, and the parameters of the power control include open-loop power control parameters P_{O_PUCCH} and so on. As another example, the PUCCH transmitting the HARQ-ACK for the unicast PDSCH uses P_{O_PUCCH_1} for the power control, and the PUCCH transmitting the HARQ-ACK for the multicast PDSCH uses P_{O_PUCCH_2} for the power control.

In addition, one UE may be configured with a plurality of group-common power control RNTIs, for example, a TPC-PUCCH-RNTI-1 is used for scrambling the CRC of the DCI carrying the power control command for the PUCCH transmitting the unicast HARQ-ACK, and for example, a TPC-PUCCH-RNTI-2 is used for scrambling the CRC of the DCI carrying the power control command for the PUCCH transmitting the multicast HARQ-ACK, so that the group-common TPC command could be flexibly transmitted.

Twelfth Implementation

A method for transmitting a Downlink Assignment Indicator (DAI) according to an embodiment of the present disclosure will be described below.

Example 12.1

The DCI scheduling the multicast PDSCH includes K_1 DAIs, such as a DAI field. Each DAI is used to count the HARQ-ACK transmitted by one UE, and K_1 is a positive integer. The UE obtains a value of K_1 by receiving the higher layer signaling configuration, and the UE obtains the DAI as the count of the HARQ-ACKs transmitted by the UE by receiving the higher layer signaling configuration (for example, the DAI field includes a counter DAI and a total DAI or only includes the counter DAI), for example, the field DAI-m is the count used for the HARQ-ACK transmitted by the UE-m. With this method, it can prevent the base station and UE from misunderstanding the bit number of the HARQ-ACK.

Example 12.2

The DAI field is located in the downlink control signaling (DCI) in the PDSCH resource. At this time, the DCI scheduling multicast PDSCH may be divided into two parts: one part of the DCI is transmitted on the PDCCH for scheduling the multicast PDSCH, called as the first part of the DCI; and the other part of the DCI is transmitted on the multicast PDSCH scheduled by the PDCCH, called as the second part of the DCI, as shown in FIG. 21.

The DAI field is included in the second part of the DCI and includes K_2 DAI field indications. K_2 is a positive integer. Each DAI field is used to count the HARQ-ACKs of one UE. The UE obtains the DAI field for the transmission of the UE by receiving the higher layer signaling configuration. For example, the field DAI-m is the DAI field for the transmission of the UE-m, the UE uses the DAI field to count the HARQ-ACKs, and the UE obtains the value of K_2 by receiving the higher layer signaling configuration.

This method is advantageous in that the DCI is divided into two parts. The number of bits in the first part of the DCI may be the same as the number of bits in the DCI for scheduling the unicast PDSCH, so that when the UE supports both multicast and unicast, the number of DCIs with different sizes for PDCCH blind detection is not increased, and the DAI can be indicated more flexibly in the second part of the DCI.

In an example, the DAI field in the second part of the DCI may be enabled/disabled with a newly added field(s), reinterpreted fields and/or reserved fields in the first part of the DCI, and the enable/disable field can be indicated by a bitmap method. The bit number K_3 of the enable/disable field is configured by the higher layer signaling, and each bit of the K_3 bits in the enable/disable field is used to enable/disable K_4 (K_4 is configured by the higher layer signaling, and K_4 is a positive integer) DAI fields. For example, when the bit value is “0”, the second part of the DCI does not include the corresponding K_4 DAI fields. When the bit value is “1”, the second part of the DCI includes the corresponding K_4 DAI fields, and this method can save the resource occupied by the second part of the DCI.

In one example, at least one of the PRI field, TPC command field, and DAI field in the second part of DCI A field may be enabled/disabled with a newly added field(s), reinterpreted fields and/or reserved fields in the first part of DCI. The enable/disable field may be indicated by a bitmap method. The bit number K_5 of the enable/disable field is configured by the higher layer signaling, and each bit of the K_5 bits in the enable/disable field is used to enable/disable K_6 (K_6 is configured by higher layer signaling, and K_6 is a positive integer) PRI fields, TPC command fields and DAI fields. For example, when the bit value is “0”, the second part of the DCI does not include the corresponding K_6 PRI fields, TPC command field and DAI field. When the bit value is “1”, the second part of DCI includes the corresponding K_6 PRI fields, TPC command field and DAI field. This method can save the resource occupied by the second part of DCI.

Example 12.3

The DCI scheduling multicast PDSCH may comprise no DAI field, or the DAI field in the DCI scheduling multicast PDSCH is used as a reserved bit, or reinterpreted as other fields, for example, as the enable/disable field of PUCCH resource.

Thirteenth Implementation

A HARQ-ACK transmission method for multicast PDSCH according to the embodiment of the present disclosure will be described below.

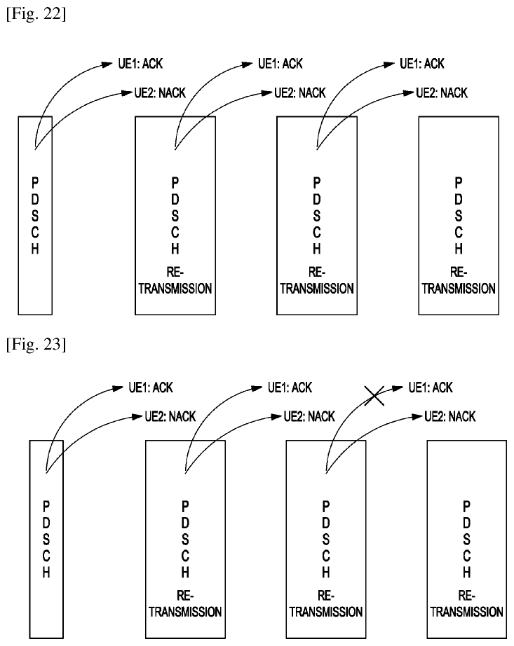

FIG. 22 shows a schematic diagram of a HARQ-ACK transmission method for multicast PDSCH.

When the multicast PDSCH is scheduled by Downlink Control Information (DCI) in a Common Search Space (CSS) and received by multiple UEs, the different UEs may use different PUCCH resources to feed back their respective HARQ-ACKs, if the UE decodes the PDSCH correctly, the UE feeds back ACK, and if the UE does not decode the PDSCH correctly, the UE feeds back NACK. At this time, there will be a situation where some UEs receive the PDSCH several times but cannot decode it correctly, so they feed back NACK several times, and then the base station retransmits the multicast PDSCH over and over, while some UEs decode the PDSCH correctly as they receive the PDSCH at the first time, but feed back ACKs for the same PDSCH for many times, as shown in FIG. 22.

FIG. 23 shows a schematic diagram of a HARQ-ACK transmission method for multicast PDSCH according to an embodiment of the present disclosure.

For multiple retransmissions of the same multicast PDSCH, the multiple feedbacks of ACKs from the UE to the base station will occupy more PUCCH resources and consume the power of UE, and a certain number of feedbacks of ACKs may enable the base station to receive it reliably. Therefore, in order to save the PUCCH resources and reduce the power consumption of the UE, according to the embodiment of the present disclosure, a maximum number of retransmissions may be determined for the HARQ-ACKs for the same multicast physical downlink shared channel (PDSCH).

For example, it can be determined that for the multiple retransmissions of the same multicast PDSCH, the number of times that the UE feeds back ACKs to the base station is A, and A is a positive integer, and the UE may obtain a value of A by receiving the higher layer signaling configuration or the value may be preset via protocols.

As shown in FIG. 23, A is equal to 2. When UE1 receives the PDCCH that schedules the same multicast PDSCH for the first time and the second time, it feeds back ACKs on the corresponding PUCCH resources respectively. When UE1 receives the PDCCH that schedules the same multicast PDSCH for the third time, it does not feed back ACK on the corresponding PUCCH resource.

Fourteenth Implementation

A HARQ combining method between multiple transmissions and retransmissions of the multicast PDSCH will be described below.

FIG. 24 shows a schematic diagram in which different UEs use the same PUCCH resource to feed back HARQ-ACK information

When different UEs use the same PUCCH resource to feed back HARQ-ACK information, if the UE decodes the PDSCH correctly, the UE does not feed back HARQ-ACK information. If the UE receives the PDCCH but does not decode the PDSCH correctly, the UE feeds back NACK on the PUCCH resource, this PUCCH resource is shared by the multicast UEs, as shown in FIG. 24. However, because the UE misses the PDCCH, the base station and the UE may have different understandings of the received multicast PDSCH, which results in the UE combining the multicast PDSCH with different information.

In order to prevent combining of the multicast PDSCH with different information, a time window for the multicast PDSCH may be set. In one example, information of the time window for the multicast PDSCH is received, and the multicast PDSCH is received according to the information. Only the multicast PDSCH transmitted within the time window may be combined, and the multicast PDSCH transmitted within the time window and the multicast PDSCH transmitted outside the time window cannot be combined, so as to avoid the combining of the multicast PDSCHs with different information due to missing PDCCH.

The time unit of the time window may be a time slot, subframe, millisecond, etc., and the UE may obtain a length of the time window by receiving the higher layer signaling configuration.

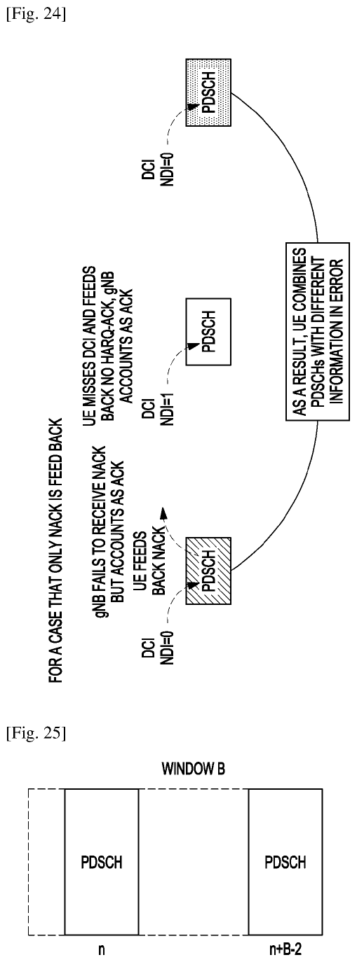

FIG. 25 shows a schematic diagram of a multicast PDSCH within a time window according to an embodiment of the present disclosure.

For example, assuming that the time window includes B time slots, and one or more multicast PDSCHs with the same HARQ process number within the time window may be combined. As shown in FIG. 25, the multicast PDSCH at time slot n and the multicast PDSCH at time slot n+B-2 are within a time window B, and the multicast PDSCH at time slot n and the multicast PDSCH at time slot n+B-2 may be combined.

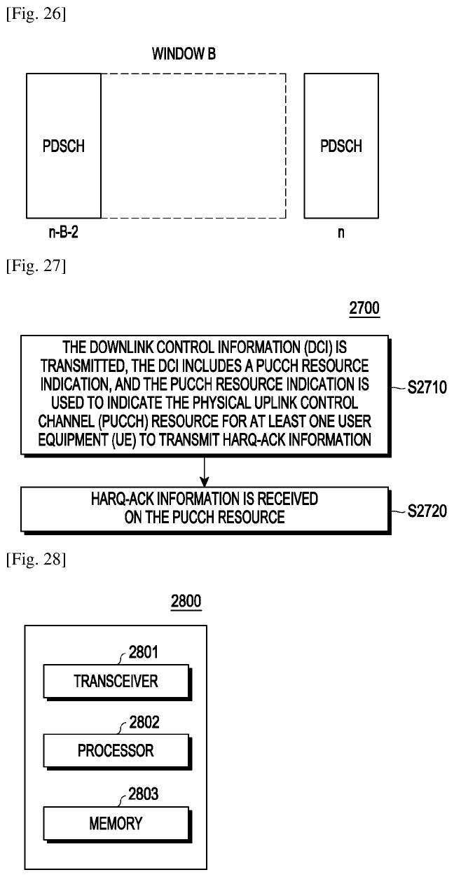

FIG. 26 shows a schematic diagram of a multicast PDSCH within a time window and a multicast PDSCH outside the time window according to an embodiment of the present disclosure.

As shown in FIG. 26, the multicast PDSCH at time slot n and the multicast PDSCH at time slot n-B-2 are not within the same time window B, and the multicast PDSCH at time slot n and the multicast PDSCH at time slot n-B-2 may not be combined. B is a positive integer, and the UE may obtain the value of B by receiving signaling. For example, the UE may obtain the value of B by receiving the higher layer signaling configuration.

With this method, it can prevent the UE from combining multicast PDSCHs with different information due to UE missing PDCCH and base station receiving NACK in error.

FIG. 27 shows a schematic diagram of a method 2700 for receiving hybrid automatic repeat request-acknowledgement (HARQ-ACK) information according to an embodiment of the present disclosure. The method 2700 may be implemented on the base station side.

As shown in FIG. 27, at step S2710, the downlink control information (DCI) is transmitted, the DCI includes a PUCCH resource indication, and the PUCCH resource indication is used to indicate the physical uplink control channel (PUCCH) resource for at least one user equipment (UE) to transmit HARQ-ACK information.

At step S2720, HARQ-ACK information is received on the PUCCH resource.

Therefore, according to the embodiments of the present disclosure, the HARQ-ACK feedback information for the multicast PDSCH can be accurately transmitted by using reasonable power and using as few PUCCH resources as possible on the premise that the multicast technology can save PDSCH and PDCCH.

The specific method for receiving HARQ-ACK information on the base station side is similar to the various implementations described above, and the specific details will not be repeated here.

In an example, a number of the PUCCH resource indications is one, and a value of the PUCCH resource indication indicates one of multiple sets of PUCCH resource configured by a higher layer signaling, and each of the PUCCH resource included in the indicated set of PUCCH resource is respectively used for a corresponding UE in the at least one UE.

In an example, the number of the PUCCH resource indications is more than one, and each PUCCH resource indication is respectively used to indicate the PUCCH resource for transmitting the HARQ-ACK information by the corresponding UE among the at least one UE.

In an example, the number of the PUCCH resource indications is more than one, and each PUCCH resource indication is respectively used to indicate the set of PUCCH resource for transmitting the HARQ-ACK information by a corresponding UE group among the at least one UE.

In an example, the PUCCH resource indication includes a PUCCH resource indication (PRI) field.

In an example, the value of the PUCCH resource indication further indicates that some of the at least one UE do not need to transmit the HARQ-ACK information.

In an example, PUCCH candidate resources are determined through a higher layer signaling configuration; and the physical uplink control channel (PUCCH) resource for transmitting the HARQ-ACK information is determined from the PUCCH candidate resources according to the PUCCH resource indication.

In an example, a transmission power control (TPC) command is included in the DCI, and the method further comprises: determining whether to apply the TPC command according to a time unit where the DCI is located.

In an example, a plurality of transmission power control (TPC) commands are further included in the DCI, and each of the plurality of TPC commands corresponds to a corresponding UE and/or a corresponding UE group among the at least one UE.

In an example, parameters for power control of the PUCCH transmitting the HARQ-ACK for the multicast PDSCH are configured separately from parameters for power control of the PUCCH transmitting the HARQ-ACK for the unicast PDSCH.

In an example, the DCI further includes a plurality of downlink allocation indexes (DAIs), which are respectively used to count HARQ-ACK transmitted by the corresponding UE in the at least one UE.

In an example, the DCI further includes an enable field for at least one of: enabling or disabling the PUCCH resource; enabling or disabling the PUCCH resource indication; enabling or disabling the TPC command; and enabling or disabling the DAI.

In an example, the DCI is divided into a first part of DCI and a second part of DCI, the first part of DCI is transmitted on the physical downlink control channel (PDCCH), and the second part of DC is transmitted on the multicast physical downlink shared channel (PDSCH) scheduled by the PDCCH and includes at least one of the PUCCH resource indication, the TPC command and the DAI.

In an example, an enable field is included in the first part of the DCI, and the enable field is used for at least one of: enabling or disabling the PUCCH resource; enabling or disabling the PUCCH resource indication; enabling or disabling the TPC command; and enabling or disabling the DAI.

In an example, the method 2700 further comprises: determining a maximum number of retransmissions for the HARQ-ACK of the same multicast physical downlink shared channel (PDSCH).

In an example, the method 2700 further comprises: receiving information on a time window for the multicast PDSCH; and receiving the multicast PDSCH according to the information.

FIG. 28 shows a schematic block diagram 2800 of a device for transmitting according to an embodiment of the present disclosure. The device 2800 can be implemented on the UE side. For example, the device 2800 may be implemented to perform the methods described above with reference to FIG. 2, FIG. 11, FIG. 13, FIG. 15, FIG. 16 and FIG. 20.

As shown in FIG. 18, the device 2800 may include a transceiver 2801, a processor 2802, and a memory 2803.

The transceiver 2801 transmits and receives signals. The memory 2803 stores instructions that can be executed by the processor 2802. When the instructions are executed by the processor 2802, the processor 2802 is caused to execute the methods described above with reference to FIG. 2, FIG. 11, FIG. 13, FIG. 15, FIG. 16 and FIG. 20.

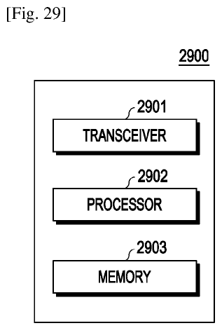

FIG. 29 shows a schematic block diagram 2900 of a device for receiving according to an embodiment of the present disclosure. The device 2900 can be implemented on the base station side. For example, the device 2900 may be implemented to perform the methods described above with reference to FIG. 10, FIG. 12, FIG. 14, FIG. 17 and FIG. 27.

As shown in FIG. 19, the device 2900 may include a transceiver 2901, a processor 2902, and a memory 2903.

The transceiver 2901 transmits and receives signals. The memory 2903 stores instructions that can be executed by the processor 2902. When the instructions are executed by the processor 2902, the processor 2902 is caused to execute the methods described above with reference to FIG. 10, FIG. 12, FIG. 14, FIG. 17 and FIG. 27.

Various embodiments of the present disclosure can be implemented as computer-readable codes embodied on a computer-readable recording medium from a specific perspective. The computer-readable recording medium is any data storage device that can store data readable by a computer system. Examples of the computer-readable recording medium may include read only memory (ROM), random access memory (RAM), compact disk read only memory (CD-ROM), magnetic tape, floppy disk, optical data storage device, carrier wave (for example, data transfer via Internet) and so on. The computer-readable recording medium can be distributed by computer systems connected via a network, and thus the computer-readable code can be stored and executed in a distributed manner. Moreover, the functional programs, codes, and code segments for realizing the various embodiments of the present disclosure can be easily explained by those skilled in the field to which the exemplary embodiments of the present disclosure are applied.

It will be understood that the exemplary embodiments of the present disclosure may be implemented in the form of hardware, software, or a combination of hardware and software. The software can be stored as program instructions or computer readable code executable on a processor on a non-transitory computer readable medium. Examples of non-transitory computer-readable recording media include magnetic storage media (for example, ROM, floppy disk, hard disk, etc.) and optical recording media (for example, CD-ROM, digital video disk (DVD), etc.). The non-transitory computer-readable recording medium may also be distributed on a network-coupled computer system, so that the computer-readable code is stored and executed in a distributed manner. The medium can be read by the computer, stored in the memory, and executed by the processor. The various embodiments may be implemented by a computer or a portable terminal including a controller and a memory, and the memory may be a non-transitory computer-readable recording medium suitable for storing the program(s) having instructions to implement the exemplary embodiments of the present disclosure Example. The present disclosure can be realized by a program having codes for specifically implementing the apparatus and methods described in the claims, and the program is stored in a machine (or computer) readable storage medium. The program may be carried electronically on any medium, such as a communication signal transferred via a wired or wireless connection, and the present disclosure suitably includes its equivalents.

Although the present disclosure has been described in connection with some embodiments, the present disclosure is not limited to the specific form set forth herein. Instead, the scope of the present disclosure is limited only by the appended claims. In addition, although one feature may be described in conjunction with a particular embodiment, those skilled in the art will recognize that various features of the described embodiments can be combined according to the present disclosure. In the claims, the term “comprising” does not exclude the presence of other elements or steps.

In addition, although listed separately, multiple devices, elements, or method steps may be implemented by, for example, a single unit or processor. In addition, although individual features may be included in different claims, these features may be advantageously combined, and the inclusion in different claims does not mean that a combination of features is not feasible and/or disadvantageous. In addition, the inclusion of a feature in a class of claims does not imply a restriction on that class, but rather an indication that the feature is also applicable to other classes of claims (if appropriate).

The above are only specific embodiments of the present disclosure, but the protection scope of the present disclosure is not limited thereto. Those skilled in the art can easily conceive of changes or substitutions within the technical scope disclosed by the present disclosure, which should be covered by the protection scope of the present disclosure. Therefore, the protection scope of the present disclosure should be subject to the protection scope of the claims.

1. A method of a user equipment (UE) for transmitting hybrid automatic repeat request-acknowledgement (HARQ-ACK) information, the method comprising:
receiving downlink control information (DCI) including a physical uplink control channel (PUCCH) resource indication and a downlink assignment index (DAI), the PUCCH resource indication indicating a PUCCH resource for transmitting HARQ-ACK information by at least one UE;
determining the PUCCH resource for transmitting the HARQ-ACK information according to the PUCCH resource indication; and
transmitting the HARQ-ACK information on the determined PUCCH resource,
wherein the HARQ-ACK information is associated with a type-1 HARQ-ACK codebook, and
wherein in case that the DCI is first DCI for scheduling a multicast physical downlink shared channel (PDSCH) and the DAI is set to a value of 1, transmitting the HARQ-ACK information comprises transmitting the HARQ-ACK information only for the multicast PDSCH.

2. The method of claim 1, wherein the at least one UE includes a plurality of UEs,
wherein a value of the PUCCH resource indication indicates one of multiple sets of PUCCH resources configured by higher layer signaling, and
wherein each of the PUCCH resources included in the indicated sets of PUCCH resources is respectively used for a corresponding UE among the plurality of UEs.

3. The method of claim 1, wherein the at least one UE includes a plurality of UEs,
wherein the DCI includes a plurality of PUCCH resource indications, and
wherein each of the plurality of PUCCH resource indications is respectively used to indicate a PUCCH resource for transmitting the HARQ-ACK information by a corresponding UE among the plurality of UES.

4. The method of claim 1, wherein the at least one UE includes a plurality of UEs,
wherein the DCI includes a plurality of PUCCH resource indications, and
wherein each of the plurality of PUCCH resource indication is respectively used to indicate a set of PUCCH resources for transmitting the HARQ-ACK information by a corresponding UE group among the plurality of UEs.

5. The method of claim 1, wherein the PUCCH resource indication includes a PUCCH resource indication (PRI) field.

6. The method of claim 2, wherein the value of the PUCCH resource indication further indicates that at least one UE among the plurality of UEs doe not need to transmit the HARQ-ACK information.

7. The method of claim 1, further comprising:
determining a maximum retransmission number for the HARQ-ACK of the multicast PDSCH.

8. The method of claim 1, further comprising:
receiving information of a time window for the multicast PDSCH; and
receiving the multicast PDSCH according to the information.

9. The method of claim 1, wherein the at least one UE includes a plurality of UEs, and
wherein the DCI further includes a plurality of DAIs, which are respectively used to count HARQ-ACKs transmitted by a corresponding UE among the plurality of UE.

10. The method of claim 1, wherein when the UE supports both multicast and unicast, parameters for a power control of a PUCCH transmitting the HARQ-ACK for the multicast PDSCH are configured separately from parameters for a power control of a PUCCH transmitting the HARQ-ACK for a unicast PDSCH.

11. A method of a user equipment (UE) for transmitting hybrid automatic repeat request-acknowledgement (HARQ-ACK) information, the method comprising:
determining a total number of bits of the HARQ-ACK information;
transmitting the HARQ-ACK information with the determined total number of bits on a physical uplink control channel (PUCCH) resource;
receiving configuration information on a number of bits of the HARQ-ACK information; and
determining the number of bits of the HARQ-ACK information according to the configuration information, wherein the configuration information is a-semi-static configuration information.

12. The method of claim 11, wherein the number of bits of the HARQ-ACK information is determined based on a number of serving cells, a number of bundling windows per cell, and a number of bits of each HARQ-ACK information.

13. The method of claim 11, further comprising:
determining the number of bits of the HARQ-ACK information based on a downlink assignment index (DAI) in downlink control information (DCI) in a physical downlink control channel (PDCCH) scheduling a physical downlink shared channel (PDSCH).

14. The method of claim 11, further comprising:
receiving a downlink assignment index (DAI),
wherein determining the total number of bits of the HARQ-ACK information comprises determining the total number of bits of the HARQ-ACK information according to a transmission mode of a serving cell, when the DAI is equal to 1.

15. A user equipment (UE), comprising:
a transceiver for transmitting and receiving signals; and
a processor configured to:
receive downlink control information (DCI) including a physical uplink control channel (PUCCH) resource indication and a downlink assignment index (DAI), the PUCCH resource indication indicates a PUCCH resource for transmitting hybrid automatic repeat request-acknowledgement (HARQ-ACK) information by at least one UE;
determine the PUCCH resource for transmitting the HARQ-ACK information according to the PUCCH resource indication; and
transmit the HARQ-ACK information on the determined PUCCH resource,
wherein the HARQ-ACK information is associated with a type-1 HARQ-ACK codebook, and
wherein in case that the DCI is a first DCI for scheduling a multicast physical downlink shared channel (PDSCH) and the DAI is set to a value of 1, transmitting the HARQ-ACK information comprises transmitting HARQ-ACK information only for the multicast PDSCH.
